(19) United States
(12) Patent Application Publication
(10) Pub. No.: US 2026/0129470 A1
(43) Pub. Date: May 7, 2026

(54) INDICATING COORDINATED BEAMFORMING PARAMETERS IN ONE OR MORE SPECIAL STATION INFORMATION FIELDS

(71) Applicant: QUALCOMM Incorporated, San Diego, CA (US)

(72) Inventors: Sameer VERMANI, San Diego, CA (US); Bin TIAN, San Diego, CA (US); Youhan KIM, Saratoga, CA (US); Jialing Li CHEN, San Diego, CA (US)

(21) Appl. No.: 19/377,936

(22) Filed: Nov. 3, 2025

Related U.S. Application Data
(60) Provisional application No. 63/716,522, filed on Nov. 5, 2024.

(51) Int. Cl. H04W 16/28; H04B 7/024

(52) U.S. Cl. CPC H04W 16/28; H04B 7/024

(57) ABSTRACT

This disclosure provides methods, components, devices and systems for techniques for coordinated beamforming (COBF). Some aspects more specifically relate to COBF sounding. In some examples, a first AP may transmit, to a second AP, a null data packet announcement indicating a sounding occasion and including one or more station information fields that indicate a plurality of parameters for a first null data packet transmission and a second null data packet transmission. The first AP may transmit, during the sounding occasion, the first null data packet transmission in accordance with the plurality of parameters and monitor for one or more sounding feedback messages associated with the first null data packet transmission and associated with the second null data packet transmission. The first AP may transmit, based at least in part on the one or more sounding feedback messages, a coordinated beamforming transmission.

### CROSS REFERENCE

The present Application for Patent claims the benefit of U.S. Provisional Patent Application No. 63/716,522 by Vermani et al., entitled “INDICATING COORDINATED BEAMFORMING PARAMETERS IN A SINGLE SPECIAL STA INFO FIELD,” filed Nov. 5, 2024, assigned to the assignee hereof, and expressly incorporated by reference herein.

### TECHNICAL FIELD

This disclosure relates generally to wireless communication and, more specifically, to techniques for coordinated beamforming and indication of related parameters.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

A method by a first access point (AP) is described. The method may include transmitting, to a second AP, a null data packet announcement, where the null data packet announcement indicates a sounding occasion and includes one or more station information fields that indicate a set of multiple parameters associated with joint sounding or sequential sounding, the one or more station information fields indicating the second AP is to transmit a null data packet transmission for the joint sounding or the sequential sounding during the sounding occasion, and transmitting, based on one or more sounding feedback messages associated with the null data packet transmission, a coordinated beamforming transmission.

A first AP is described. The first AP may include a processing system that includes processor circuitry and memory circuitry that stores code. The processing system may be configured to cause the first AP to, transmit, to a second AP, a null data packet announcement, where the null data packet announcement indicates a sounding occasion and includes one or more station information fields that indicate a set of multiple parameters associated with joint sounding or sequential sounding, the one or more station information fields indicating the second AP is to transmit a null data packet transmission for the joint sounding or the sequential sounding during the sounding occasion, and transmit, based on one or more sounding feedback messages associated with the null data packet transmission, a coordinated beamforming transmission.

Another first AP is described. The first AP may include means for a processing system that includes processor circuitry and memory circuitry that stores code, the processing system configured to cause the first AP to, means for transmitting, to a second AP, a null data packet announcement, where the null data packet announcement indicates a sounding occasion and includes one or more station information fields that indicate a set of multiple parameters associated with joint sounding or sequential sounding, the one or more station information fields indicating the second AP is to transmit a null data packet transmission for the joint sounding or the sequential sounding during the sounding occasion, and means for and transmitting, based on one or more sounding feedback messages associated with the null data packet transmission, a coordinated beamforming transmission.

A non-transitory computer-readable medium storing code is described. The code may include instructions executable by one or more processors to a processing system that includes processor circuitry and memory circuitry that stores code, the processing system configured to cause the first AP to, transmit, to a second AP, a null data packet announcement, where the null data packet announcement indicates a sounding occasion and includes one or more station information fields that indicate a set of multiple parameters associated with joint sounding or sequential sounding, the one or more station information fields indicating the second AP is to transmit a null data packet transmission for the joint sounding or the sequential sounding during the sounding occasion, and transmit, based on one or more sounding feedback messages associated with the null data packet transmission, a coordinated beamforming transmission.

In some examples of the method, first APs, and non-transitory computer-readable medium described herein, the set of multiple parameters includes two or more bits indicating a starting spatial stream index and a quantity of spatial streams for the second AP.

In some examples of the method, first APs, and non-transitory computer-readable medium described herein, the two or more bits include a first bit that indicates the starting spatial stream index and a second bit that indicates the quantity of spatial streams for the second AP.

In some examples of the method, first APs, and non-transitory computer-readable medium described herein, the two or more bits comprise two bits.

In some examples of the method, first APs, and non-transitory computer-readable medium described herein, a first value of the first bit corresponds to a first starting spatial stream index and a second value of the first bit corresponds to a second starting spatial stream index.

In some examples of the method, first APs, and non-transitory computer-readable medium described herein, a first value of the second bit corresponds to a first quantity and a second value of the second bit corresponds to a second quantity.

In some examples of the method, first APs, and non-transitory computer-readable medium described herein, the set of multiple parameters includes a parameter indicating a number of long training fields in the null data packet transmission, the number of long training fields corresponding to a matrix size.

In some examples of the method, first APs, and non-transitory computer-readable medium described herein, the parameter includes a single bit, and a first value of the single bit corresponds to a first matrix size and a second value of the single bit corresponds to a second matrix size.

In some examples of the method, first APs, and non-transitory computer-readable medium described herein, the plurality of parameters comprises a station identifier that identifies the second AP.

In some examples of the method, first APs, and non-transitory computer-readable medium described herein, the station identifier comprises a first value within a subset of values for the station identifier that identifies the second AP, and wherein an overall set of possible values for the station identifier is larger than the subset of values and includes the subset of values.

### BRIEF DESCRIPTION OF THE DRAWINGS

FIG. 1 shows a pictorial diagram of an example wireless communication network.

FIG. 2 shows an example wireless communication system that supports techniques for coordinated beamforming (COBF).

FIG. 3 shows an example of a block diagram that supports techniques for COBF

FIG. 4 shows example communication timelines that supports techniques for COBF.

FIG. 5 shows example communication timelines that support techniques for COBF.

FIG. 6 shows example communication timeline that supports techniques for COBF.

FIG. 7 shows example communication timeline that supports techniques for COBF.

FIG. 8 shows examples of physical layer (PHY) protocol data units (PPDUs) that support techniques for COBF.

FIG. 9 shows an example process flow that supports techniques for COBF.

FIG. 10 shows a block diagram of an example wireless communication device that supports techniques for COBF.

FIGS. 11 through 16 show flowcharts illustrating example processes performable by or at a first access point (AP) that supports techniques for COBF.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks, such as Wi-Fi networks, may support coordinated beamforming (COBF) between devices to suppress interference. For example, a Wi-Fi network may include multiple basic service sets (BSSs), where a single BSS may include one or more devices, such as an access point (AP) connected with one or more stations (STAs). In some cases, BSSs may overlap in communication resources for corresponding coverage areas, causing interference on shared frequency bands. To suppress interference experienced by a STA due to overlapping BSS (OBSS) interference, APs may coordinate to transmit using selected spatial streams to mitigate interfering signals. In accordance with COBF, a first AP or a second AP may beamform signaling to focus radio frequency (RF) energy toward respective in-BSS STAs and away from respective OBSS STAs. In some examples, devices may implement symmetric COBF where each AP of the network may participate in suppressing interference. Techniques may be lacking for supporting group formation for COBF, sounding for COBF and COBF transmissions.

Various aspects relate generally to COBF group formation, COBF sounding and COBF transmission to suppress interference between devices. Some aspects more specifically relate to a sharing AP transmitting a null data packet announcement (NDPA). In some examples, the NDPA may indicate a sounding occasion and one or more common parameters for a first null data packet (NDP) transmission for a joint sounding. The sharing AP may transmit, during the sounding occasion, the first NDP in accordance with the one or more common parameters. The sharing AP may monitor for a joint sounding feedback associated with first NDP transmission and associated with a second NDP transmission during sounding occasion from a shared AP. The sharing AP may transmit, based on the joint sounding feedback, a COBF transmission. Additionally, or alternatively, the NDPA may include a COBF AP identifier (APID), a sounding dialog token indicating the joint sounding, a station information field for the shared AP. In some examples, the sharing AP may transmit signaling indicating a COBF opportunity as a beam signal.

Particular aspects of the subject matter described in this disclosure can be implemented to realize one or more of the following potential advantages. In some examples, by transmitting the null data packet announcement, the described techniques can be used to efficiently provide the information for the joint null data packet in the sounding phase for COBF. Further, by transmitting the beacon signal indicating a COBF opportunity, the group formation phase of COBF may be efficiently performed.

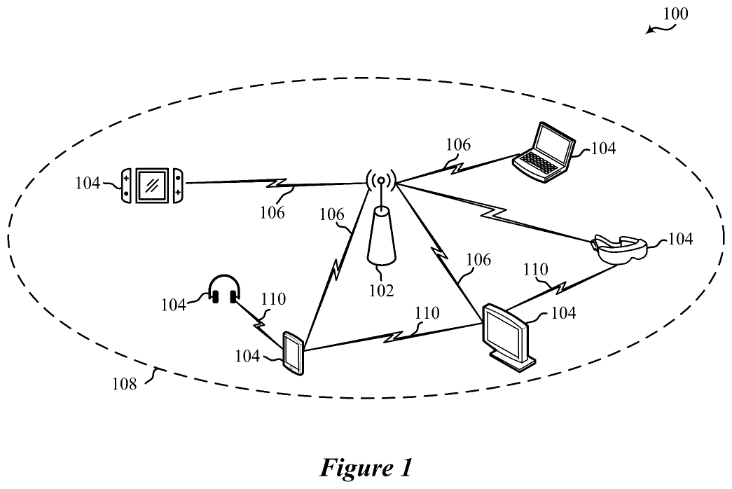

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHZ-24.25 GHZ), FR4a or FR4-1 (52.6 GHz-71 GHz), FR4 (52.6 GHZ-114.25 GHZ), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHZ, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHZ, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some examples, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping basic service set (OBSS) preamble detection (PD) value, or a threshold of detected interference below which the device may transmit at a lower transmit power.

Some wireless communication networks, such as Wi-Fi networks, may support COBF between devices to suppress interference. For example, a Wi-Fi network may include multiple BSSs, where a single BSS may include one or more devices, such as an AP 102 connected with one or more STAs 104. In some cases, BSSs may overlap in communication resources for corresponding coverage areas, causing interference on shared frequency bands. To suppress interference experienced by a STA 104 due to OBSS interference, APs 102 may coordinate to transmit using selected spatial streams to mitigate interfering signals. In some examples, devices may implement symmetric COBF where each AP 102 of the network may participate in suppressing interference. In some scenarios, the APs 102 may lack efficient mechanism for group formation for COBF, sounding for COBF and COBF transmissions.

Various aspects relate generally to COBF group formation, COBF sounding and COBF transmission to suppress interference between devices. Some aspects more specifically relate to a sharing AP 102 transmitting a null data packet announcement (NDPA). In some examples, the NDPA may indicate a sounding occasion and one or more common parameters for a first null data packet (NDP) transmission for a joint sounding. The sharing AP 102 may transmit, during the sounding occasion, the first NDP in accordance with the one or more common parameters. The sharing AP 102 may monitor for a joint sounding feedback associated with first NDP transmission and associated with a second NDP transmission during sounding occasion from a shared AP 102. The sharing AP 102 may transmit, based on the joint sounding feedback, a COBF transmission. Additionally, or alternatively, the NDPA may include a COBF AP identifier (APID), a sounding dialog token indicating the joint sounding, a station information field for the shared AP 102. In some examples, the sharing AP 102 may transmit signaling indicating a COBF opportunity as a beam signal.

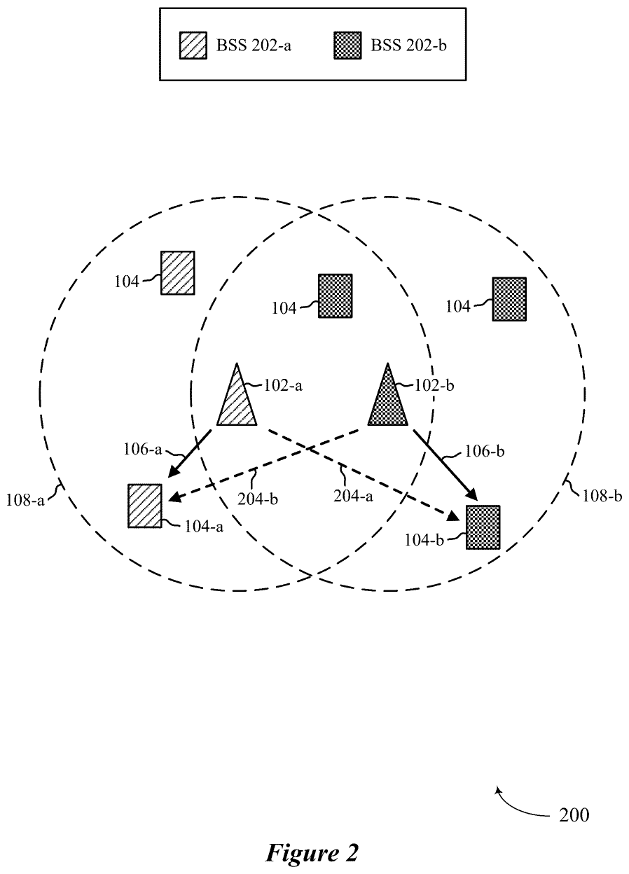

FIG. 2 shows an example of a wireless communication system 200 that supports techniques for COBF. The wireless communication system 200 may implement or be implemented to realize aspects of the wireless communication network 100. For example, the wireless communication system 200 may include an AP 102-a and an AP 102-b, each of which may be an example of an AP 102 as illustrated by and described with reference to FIG. 1. Further, the wireless communication system 200 may include various STAs 104, including a STA 104-a and a STA 104-b, each of such various STAs 104 being an example of a STA 104 as illustrated by and described with reference to FIG. 1. The AP 102-a may transmit to the STA 104-a via a communication link 106-a and the AP 102-b may transmit to the STA 104-b via a communication link 106-b.

The AP 102-a may serve devices within a geographic area 108-a associated with a BSS 202-a and the AP 102-b may serve devices within a geographic area 108-b associated with a BSS 202-b. In some aspects, the BSS 202-a may be an OBSS relative to the BSS 202-b. In other words, from the perspective of the BSS 202-a, the BSS 202-b may be an OBSS and, from the perspective of the BSS 202-b, the BSS 202-a may be an OBSS. As such, from the perspective of devices of the BSS 202-a, the AP 102-a and the STA 104-a may be understood as a BSS AP and a BSS STA, respectively, and the AP 102-b and the STA 104-b may be understood as an OBSS AP and an OBSS STA, respectively. Likewise, from the perspective of devices of the BSS 202-b, the AP 102-a and the STA 104-a may be understood as an OBSS AP and an OBSS STA, respectively, and the AP 102-b and the STA 104-b may be understood as a BSS AP and a BSS STA, respectively. In some aspects, which of the BSS 202-a or the BSS 202-b is designated as the OBSS may be associated with which of the AP 102-a or the AP 102-b is a TXOP winner. For example, if the AP 102-a wins a TXOP, the BSS 202-a may be understood as the BSS and the BSS 202-b may be understood as the OBSS. Alternatively, if the AP 102-b wins a transmission opportunity (TXOP), the BSS 202-a may be understood as the OBSS and the BSS 202-b may be understood as the BSS.

For a coordinated beamforming transmission, one or both of the first AP 102-a or the second AP 102-b may beamform signaling to focus radio frequency (RF) energy toward respective in-BSS stations (STAs) (such as intended receiver devices) and away from respective OBSS STAs. The AP 102-a and the AP 102-b may support one or more of various types of COBF, such as one or more of various beamforming-based AP coordination techniques. For example, the AP 102-a and the AP 102-b may support one or both of symmetric COBF and asymmetric COBF. In some cases, the AP 102-a and the AP 102-b may be a planned deployment or mesh, and the AP 102-a and the AP 102-b may support symmetric COBF. In some cases, a quantity of APs in a COBF transmission may be two or more. In some examples, the quantity of APs in a COBF transmission may be two APs due to protocol and STA side complexity. One AP may perform COBF with different APs at different times, and the AP may perform COBF with one other AP in a given transmission. One AP may perform setup of COBF with multiple APs to enable COBF opportunities.

In accordance with symmetric COBF, APs 102 of both a BSS and an OBSS may employ beamforming, such as a setting or configuring of precoding weights to enable or facilitate directional transmission, to create nulls or areas or directions of relatively low interference toward STAs of the other AP 102 irrespective of which AP 102 is a TXOP winner. For example, regardless of which of the AP 102-a or the AP 102-b obtains or wins a TXOP, the AP 102-a may employ beamforming to create a null toward the STA 104-b to reduce, minimize, or mitigate interference 204-a toward the STA 104-b as part of transmitting to the STA 104-a, and the AP 102-b may employ beamforming to create a null toward the STA 104-a to reduce, minimize, or mitigate interference 204-b toward the STA 104-a as part of transmitting to the STA 104-b. In accordance with such symmetric COBF techniques, over-the-air (OTA) interference at both the STA 104-a and the STA 104-b may be reduced, such as minimized, mitigated, or avoided, at the cost of both the AP 102-a and the AP 102-b incurring some amount of precoding loss as both the AP 102-a and the AP 102-b set precoding weights in accordance with both directivity gain and interference mitigation, instead of directivity gain alone. Further, in accordance with symmetric COBF, both the AP 102-a and the AP 102-b may be expected to gather CSI associated with OBSS STAs 104 and roughly or approximately time-synchronize their respective transmissions.

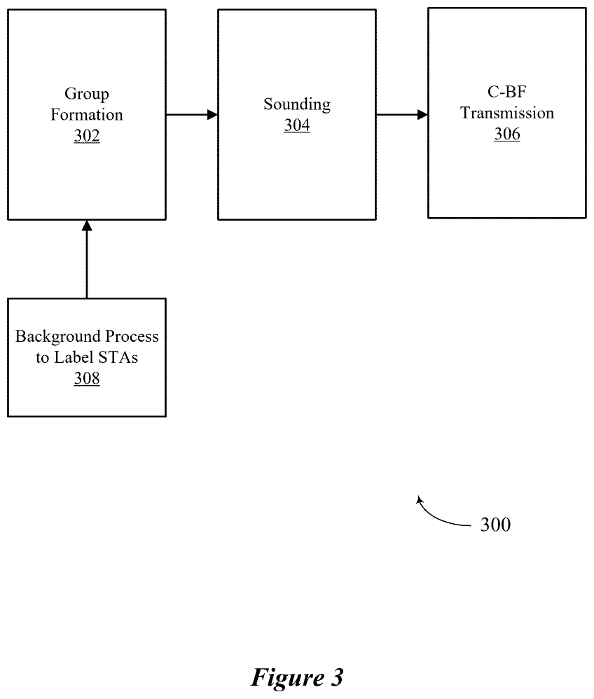

FIG. 3 shows an example of a block diagram 300 that supports techniques for COBF. The block diagram 300 illustrates the COBF protocol components. The wireless communication system 200 may implement the COBF protocol components in three main phases of COBF of the block diagram 300. The COBF three main phases include group formation phase 302, sounding phase 304, and COBF transmission phase 306.

In group formation, a COBF group may be formed including two APs, such as AP 102-a and AP 102-b, and the COBF group may carrying spatial stream split for sounding across the APs. The COBF group of AP 102-a and AP 102-b may exchange STA identifiers (STAIDs) of the recipient STA, such as STA 104-a and STA 104-b, that may be useful for precisely identifying sounding packets. The group formation phase 302 may occur infrequently. In the sounding phase, the in-BSS and OBSS channel state information (CSI) may be delivered to the AP 102-a and the AP 102-b, and the AP 102-a and AP 102-b may carry the spatial stream split at the beginning of the sounding phase 304. The sounding phase 304 may periodically occur (e.g., every 30-50 milliseconds (ms)) depending on Doppler. In the COBF transmission phase 306, one of the APs may obtain a COBF transmission TXOP. The AP 102-a and AP 102-b may obtain the COBF transmission TXOP multiple times and in some cases back-to-back between two sounding events. The frequency at which the three phases occur may not be defined, and some cases may have different rate of execution of the three phases.

In some examples, a background process of STA labeling 308 may be performed to identify which STAs, such as STA 104-a and STA 104-b, are good candidates in a BSS for the COBF. Good candidate STAs may be a function of the neighboring AP. In coordinated spatial reuse (C-SR), the process of STA labeling implemented for C-SR may be re-used to label STAs as good candidates for COBF. The STA labeling may be performed on a per-neighboring AP basis. STAs that are not good candidates for C-SR will most likely be a good candidate for COBF. Using the background process for STA labeling, the one of the AP 102-a and AP 102-b may initiate a COBF group formation procedure.

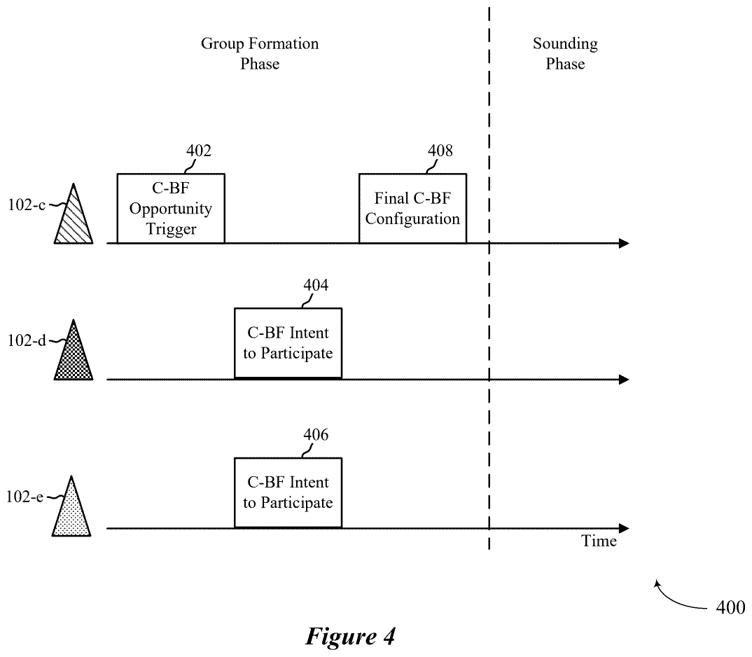

FIG. 4 shows example communication timelines 400 that support techniques for COBF. The communication timelines 400 may implement or be implemented to realize aspects of the wireless communication network 100 or the wireless communication system 200. For example, the communication timelines 400 illustrate signaling exchanges involving an AP 102-c, an AP 102-d, and an AP 102-e, which may be examples of the APs 102, the AP 102-a, and the AP 102-b, as illustrated by and described with reference to FIGS. 1 and 2. In some cases, the AP 102-c or sharing AP may initiate a COBF group formation process. In some examples, the group forming process may occur infrequently.

The AP 102-c may transmit a COBF opportunity trigger 402 to the AP 102-d and AP 102-e or shared APs. The COBF opportunity trigger 402 may include a quantity of spatial multiplexing dimensions available at the AP 102-c, a list of APs, such as AP 102-d and AP 102-e, that the AP 102-c is inviting for the COBF group, and resources for the COBF intent to participate transmissions, such as COBF intent to participate transmission 404 and COBF intent to participate transmission 406. In some cases, the AP 102-d and AP 102-e may be identified as good COBF candidates by the AP 102-c from the STA labeling background process.

In some examples, the AP 102-d may transmit the COBF intent to participate transmission 404, and the AP 102-e may transmit the COBF intent to participate transmission 406. The COBF intent to participate transmission may be transmitted using a packet, such as a transport block (TB) physical layer protocol data unit (PPDU). The COBF intent to participate transmission may include a quantity of spatial multiplexing dimensions or quantity of antennas available at the shared AP and a list of STAs that the responding AP, such as AP 102-d and AP 102-e, considers as good candidates for COBF with the AP 102-c. In some cases, the AP 102-c may transmit a final COBF configuration 408 that may contain at least an identifier for the AP(s) in two AP groups as shared AP(s) for COBF with AP 102-c or the sharing AP.

In some examples of the COBF group formation, each AP, such as the AP 102-c, the AP 102-d, and the AP 102-e, may advertise the COBF opportunity in a beacon signal. The beacon signal may indicate a quantity of spatial multiplexing dimensions or quantity of antennas available for the COBF, and a list of good candidate neighboring APs for the COBF. The list of good candidate neighboring APs may be updated in the beacon signal based on the in-BSS background process. For the advertising example, there is not explicit group formation phase, and the sounding phase may directly begin with one AP acting as the sharing AP.

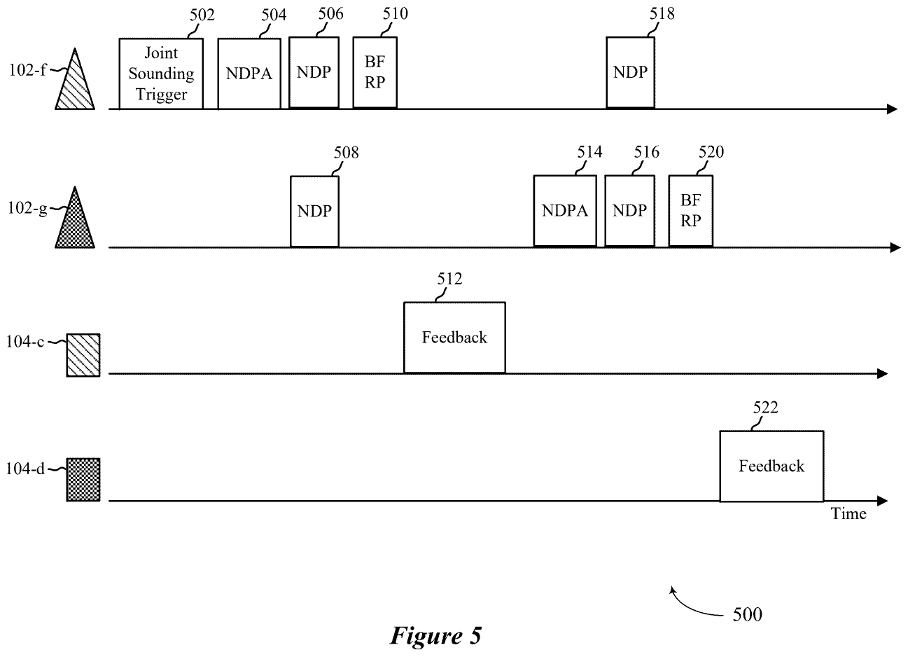

FIG. 5 shows example communication timelines 500 that support techniques for COBF. The communication timelines 500 may implement or be implemented to realize aspects of the wireless communication network 100 or the wireless communication system 200. For example, the communication timelines 500 illustrate signaling exchanges involving an AP 102-f and an AP 102-g, which may be examples of the APs 102 as illustrated by and described with reference to FIGS. 1, 2, and 4. For example, the communication timelines 500 illustrate signaling exchanges involving a STA 104-c and a STA 104-d, which may be examples of the STAs 104 as illustrated by and described with reference to FIGS. 1 and 2. In some cases, the AP 102-f, the AP 102-g, the STA 104-c and the STA 104-d may perform a joint sounding protocol or a joint sounding procedure for the sounding phase.

In some examples, the AP 102-f and the AP 102-g may exchange information or common parameters for a joint null data packet (NDP) via a null data packet announcement (NDPA). The NDPA may include a STA information field with a unique value assigned for each AP, such as AP 102-f and the AP 102-g. The NDPA may include a sounding dialog token reserved bit that indicates the NDPA signals a joint sounding. The NDPA may notify the AP 102-g, STA 104-c, and STA 104-d that a joint sounding NDP is going to be transmitted. In some cases, the AP 102-f may transmit a joint sounding trigger (502) to exchange information for the joint NDP via a separate unicast frame to the AP 102-g before transmission of the NDPA.

In some cases the NDPA frame format may be a UHR NDPA frame format. The UHR NDPA frame format may include zero, one or two special STA information fields. One option of the NDPA frame format may include a frame control field (2 octets), a duration field (2 octets), a receiver address (RA) field (6 octets), a transmitter address (TA) field (6 octets), a sounding dialog token field (1 octet), a special STA formation field, STA information fields (e.g., STA information field #1, . . . , STA information field #N) (N×2 or N×4 octets), and a frame check sequence (FCS) field (4 octets); the STA information list may include the special STA formation field and the STA information fields. Another option of the NDPA frame format may include the frame control field (2 octets), the duration field (2 octets), the RA field (6 octets), the TA field (6 octets), the sounding dialog token field (1 octet), the special STA information field, a second AP information field (which may be considered as a continuation of the special STA information field or a second special STA information field), the STA information fields (e.g., STA information field #1, . . . , STA information field #N) (N×2 or N×4 octets), and the FCS field (4 octets); the STA information list may include the special STA formation field, the second AP information field, and the STA information fields.

In some examples, two options may be used to indicate the UHR NDPA or the existence of the one or two special STA information fields. In a first option, the indication may be in the sounding dialog token field. An NDPA variant extension subfield (2-3 bits), a sounding type subfield (1-2 bits), a second AP sounding subfield (1-2 bits), or a combination thereof may be added to indicate the PHY version (e.g., UHR) and the sounding type, and one special information field (4 octets) may be used. In a second option, the indication may be through a special association identifier (AID11) subfield value to self-identify the special STA information field and a possible next STA information field also being a special STA information field (i.e., the continuation of the first special STA information field, or considered as a second AP information field), and 1-2 special STA information fields (of 4 octets each) may be used.

In some cases, the special STA information field may carry the following information:

| Field | Number of Bits & Description |
|---|---|
| AID11 | 11 bit COBF APID is self-picked but updated if collision is |
| | noticed, used to identify the second AP, i.e., AP 102-g or AP |
| | 102-i |
| Bandwidth | 3 bits to indicate |
| | 20 MHz/40 MHz/80 MHz/160 MHz/320 MHz-1/320 MHz-2 |
| | or 2 bits to indicate |
| | 80 MHz/160 MHz/320 MHZ-1/320 MHz-2 |
| Punctured Channel | 5 bits (same definition as the Punctured Channel |
| Information | Information subfield in U-SIG) |
| NLTF | 1 bit to indicate 4 or 8 number of LTFs (4LTFs means it is |
| | cross-BSS sounding in sequential sounding; 8LTFs means it |
| | is joint sounding), or 2-3 bits to indicate more values that |
| | may include {2, 4, 6, 8, 10, 12, 14, 16} or a subset of it |
| Coordinated | 1 bit to indicate cross-BSS sounding in sequential sounding |
| sounding type | or joint sounding (they imply 4 or 8 NLTF, respectively) |
| Nrx reduction | 1 bit to indicate reducing the Nrx to Nc for all STAs (This is |
| indication | only meaningful for the cross-BSS sounding in sequential |
| | sounding) |
| Starting Stream index | 2 bits (to indicate {3, 4, 5, 6}) or 3 bits (to indicate {0, 3, 4, |
| for the second AP | 5, 6}) |
| Nss for the first | 2 bits (to indicate {1, 2, 3, 4}, or {2, 3, 4, 5}) or 3 bits (to |
| AP in NDP | indicate {0, 1, 2, 3, 4, 5}) |
| Nss for the second | 2 bits (to indicate {1, 2, 3, 4} or {2, 3, 4, 5}) |
| AP in NDP | |
| Total Nss in NDP | 3 bits (to indicate {1, 2, 3, 4, 5, 6, 7, 8}) |
| GI + LTF | 1 bit (to indicate 2x LTF + 1.6CP or 4x LTF + 3.2CP), or |
| | remove this bit (only 2x LTF + 1.6 us CP), or 2 bits (same |
| | definition as the GI + LTF in the common field of EHT-SIG |
| | or UHR-SIG) |
| TXOP Duration | 7 bits |
| Tx EVM Info | 2 bits (This may be only meaningful for joint sounding) |
| Disambiguition (B27 at a | Set to 1 to avoid a non-EHT/non-UHR VHT STA to wrongly |
| fixed bit location) | identify its AID in the AID12 subfield |

In some cases, the one special STA information field may carry four octets or 32 bits. If a coordinated sounding type (joint NDP or sequential NDP (e.g., cross-BSS NDP)) is indicated, the NLTF and Nrx reduction indication may be fixed with NLTF=4 and Nrx reduction ON being used in the cross-BSS NDP, and NLTF=8 being used in the joint NDP, and the starting stream index for the second AP uses 2 bits rather than 3 bits. At least one of the starting stream index for second AP, Nss for the first AP in NDP, and total Nss in the NDP may be needed but not both of them are needed, because the quantities are related. For example, if the first AP participates in the NDP transmission and uses the first one or more spatial streams, the starting stream index for the second AP equals the Nss for the first AP in NDP plus one. For another example, if the second AP uses the first one or more spatial streams, the starting stream index for the second AP doesn't need to be indicated, and the second AP only needs to know at least two of the Nss for the first AP in NDP, the Nss for the second AP in NDP and the total Nss in NDP.

In some cases, two options for a variation of the special STA information field may carry the following information:

| Field | Number of Bits & Description |
|---|---|
| AID11 | 11 bit COBF APID is self-picked but updated if |
| | collision is noticed, used to identify the second AP |
| Bandwidth | 3 bits to indicate 20 MHz/40 MHz/80 |
| | MHz/160 MHz/320 MHz-1/320 MHz-2 |
| Punctured Channel | 5 bits (same definition as the Punctured Channel |
| Information | Information subfield in U-SIG) |
| NLTF | 1 bit to indicate 4 or 8 number of LTFs (4LTFs |
| | means it is cross-BSS sounding in sequential |
| | sounding; 8LTFs means it is joint sounding) |
| Starting Stream | 2 bits (to indicate {3, 4, 5, 6}) |
| index for the | |
| second AP | |
| Nss for the second | 2 bits (to indicate {1, 2, 3, 4)) |
| AP in NDP | |
| TXOP Duration | 7 bits |
| Disambiguition | Set to 1 to avoid a non-EHT/UHR VHT STA to |
| (B27) | wrongly identify its AID in the AID12 subfield |

| Field | Number of Bits & Description |
|---|---|
| AID11 | 11 bit COBF APID is self-picked but updated if |
| | collision is noticed, used to identify the second AP |
| Bandwidth | 3 bits to indicate 20 MHz/40 MHz/80 MHz/160 |
| | MHz/320 MHz-1/320 MHz-2 |
| Punctured Channel | 5 bits (same definition as the Punctured Channel |
| Information | Information subfield in U-SIG) |
| Coordinated | 1 bit to indicate cross-BSS sounding in sequential |
| sounding type | sounding or joint sounding (they imply 4LTFs or |
| | 8LTFs, respectively) |
| Starting Stream | 2 bits (to indicate {3, 4, 5, 6}) |
| index for the | |
| second AP | |
| Nss for the second | 2 bits (to indicate {1, 2, 3, 4)) |
| AP in NDP | |
| TXOP Duration | 7 bits |
| Disambiguition | Set to 1 to avoid a non-EHT/non-UHR VHT STA to |
| (B27) | wrongly identify its AID in the AID12 subfield |

In some cases, two additional options for a variation of the special STA information field may carry the following information

| Field | Number of Bits & Description |
|---|---|
| AID11 | 11 bit COBF APID is self-picked but updated if |
| | collision is noticed, used to identify the second AP |
| Bandwidth | 3 bits to indicate 20 MHz/40 MHz/80 MHz/160 |
| | MHz/320 MHz-1/320 MHz-2 |
| Punctured Channel | 5 bits (same definition as the Punctured Channel |
| Information | Information subfield in U-SIG) |
| Starting Stream | 3 bits (to indicate {0, 3, 4, 5, 6}) |
| index for the | |
| second AP | |
| Nss for the second | 2 bits (to indicate {1, 2, 3, 4}) |
| AP in NDP | |
| TXOP Duration | 7 bits |
| Disambiguition | Set to 1 to avoid a non-EHT/non-UHR VHT STA to |
| (B27) | wrongly identify its AID in the AID12 subfield |

| Field | Number of Bits & Description |
|---|---|
| AID11 | 11 bit COBF APID is self-picked but updated if |
| | collision is noticed, used to identify the second AP |
| Bandwidth | 2 bits to indicate 80 MHz/160 MHz/320 |
| | MHz-1/320 MHz-2 |
| Punctured Channel | 5 bits (same definition as the Punctured Channel |
| Information | Information subfield in U-SIG) |
| Starting Stream | 2 bits (to indicate {3, 4, 5, 6}) |
| index for the | |
| second AP | |
| Nss for the second | 2 bits (to indicate {1, 2, 3, 4}) |
| AP in NDP | |
| TXOP Duration | 7 bits |
| Tx EVM Info | 2 bits |
| Disambiguition | Set to 1 to avoid a non-EHT/non-UHR VHT STA to |
| (B27) | wrongly identify its AID in the AID12 subfield |

In some examples, the UHR indication and special STA information field may carry the following information for a case with two special STA information fields with 4 octets each and each STA information field having B27 as the disambiguation bit and unused bits are a set of reserved bits omitted from the example:

| Special | | |
|---|---|---|
| STA Info | | |
| Field | | |
| Number | Field | Number of Bits & Description |
| 1st | AID11 | 11bit AID11 set to a particular value (e.g., 2007-2047, in |
| | | particular, 2008-2042 or 2046) to self-identify the special |
| | | STA info field(s) |
| | NDP | 2-3 bits to further identify the variant (e.g., EHT, UHR and |
| | Announcement | future generations, or UHR and future generations) |
| | Variant | |
| | Extension | |
| | Sounding Type | 1 bit to indicate Non-TB sounding or TB sounding, or 2 bits |
| | | to indicate Non-TB sounding, TB sounding, cross-BSS |
| | | sounding (which implies 4 LTFs), or joint sounding (which |
| | | implies 8 LTFs) |
| | Disambiguition | Set to 1 to avoid a non-EHT/non-UHR VHT STA to wrongly |
| | (B27) | identify its AID in the AID12 subfield |
| 2nd | AID11 | 11 bit COBF APID is self-picked but updated if collision is |
| | | noticed, used to identify the second AP |
| | Disambiguition | Set to 1 to avoid a non-EHT/non-UHR VHT STA to wrongly |
| | (B27) | identify its AID in the AID12 subfield |
| Either 1st | Bandwidth | 3 bits to indicate |
| or 2nd | | 20 MHz/40 MHz/80 MHz/160 MHz/320 MHz-1/320 MHz-2 |
| | | or 2 bits to indicate |
| | | 80 MHz/160 MHz/320 MHz-1/320 MHz-2 |
| | Punctured | 5 bits (same definition as the Punctured Channel |
| | Channel | Information subfield in U-SIG) |
| | Information | |
| | NLTF | 1 bit to indicate 4 or 8 number of LTFs (4LTFs means it is |
| | | cross-BSS sounding in sequential sounding; 8LTFs means it |
| | | is joint sounding), or 2-3 bits to indicate more values that |
| | | may include {2, 4, 6, 8, 10, 12, 14, 16} or a subset of it |
| | Starting Stream | 2 bits (to indicate {3, 4, 5, 6}) or 3 bits (to indicate {0, 3, 4, |
| | index for the | 5,6}) |
| | second AP | |
| | Nss for the first | 2 bits (to indicate {1, 2, 3, 4} or {2, 3, 4, 5}) or 3 bits (to |
| | AP in NDP | indicate {0, 1, 2, 3, 4, 5)) |
| | Nss for the | 2 bits (to indicate {1, 2, 3, 4} or {2, 3, 4, 5}) |
| | second AP in | |
| | NDP | |
| | Total Nss in | 3 bits (to indicate {1, 2, 3, 4, 5, 6, 7, 8}) |
| | NDP | |
| | GI + LTF | 1 bit (2x LTF + 1.6CP or 4x LTF + 3.2CP) or remove this bit |
| | | (only 2x LTF + 1.6 us CP) or 2 bits (same definition as the |
| | | GI + LTF in the common field of EHT-SIG or UHR-SIG) |
| | TXOP Duration | 7 bits |
| | Nrx reduction | 1 bit to indicate reducing the Nrx to Nc for all STAs (This |
| | indication | may be only meaningful for the cross-BSS sounding in |
| | | sequential sounding) |
| | Tx EVM Info | 2 bits (This may be only meaningful for joint sounding) |

In some examples, the information to be conveyed to the second AP, such as via the NDPA or the joint sounding trigger may include a STAID, such as a special value in the case of the NDPA carrying the STAID, that may be an eleven bit COBF APID. The STAID may be referred to as a COBF special APID. In some cases, the COBF APID may be self-picked by the second AP, and updated if collision is noticed; collisions may be resolved in a manner similar to resolving BSS color collisions. In some cases, the COBF special APID may be advertised in the beacon as a form of an AP identifier. The information or common parameters to be conveyed to the second AP in the NDPA may include a bandwidth (3 bits), punctured channel information (5 bits), number of long training field (NLTF) symbols in NDP of P-matrix size (1 bit of 4 or 8), a starting stream index for the second AP in the NDP (2 bits of 2, 3, 4, or 5), a number of spatial streams (Nss) for the first AP in the NDP (2 bits of 1, 2, 3, or 4, or 2 bits of 2, 3, 4, 5), a number of spatial streams (Nss) for the second AP in the NDP (2 bits of 1, 2, 3, or 4, or 2 bits of 2, 3, 4, 5), guard interval (GI) and long training field (LTF) symbol duration (1 bit of 2× LTF+1.6CP and 4× LTF+3.2CP where CP is the cyclic prefix, where 1× LTF, 2× LTF and 4× LTF, respectively, have 3.2 us, 6.4 us, and 12.8 us symbol durations for each LTF symbol, before GI insertion), a BSS color (6 bits), and a TXOP duration in the joint NDP (7 bits). In some cases, the BSS color may be the BSS color of the first AP or the BSS color of the second AP. In some cases, the BSS color may be indicated in the COBF group formation phase, such as when the information conveyed in a 32-bit STA information field as part of the NDPA. In some examples, the information conveyed to the second AP may include a PHY version identifier. In some cases, two STA information fields may be used for the information conveyed to the second AP.

In some examples, the NDPA design for joint sounding may include information for joint NDP. For example, the NDPA may include fields and subfields with information for the joint sounding procedure. In some cases, the STA information field may include a special identification value for the second AP (e.g., AP 102-g). The NDPA may include a sounding dialog token number subfield's reserved state to indicate that the NDPA indicates joint sounding. In some cases, a subfield within the sounding dialog token number subfield being set to a certain value may indicate UHR null data packet announcement frame. The sounding dialog token may indicate to the second AP and possibly to the STAs (e.g., STA 104-c, and STA 104-d) that a joint sounding NDP is going to arrive. In some cases, the 8-bit sounding dialog token field may be split into two subfields: a 2-bit NDP announcement variant subfield and a 6-bit sounding dialog token number subfield. The 6-bit sounding dialog token number subfield or a subfield within the 6-bit sounding dialog token number subfield may be used to indicate joint sounding or sequential sounding. The special STA information field addressed to the second AP may provide information about the joint NDP. For example, the information may include bandwidth and punctured channel information, NLTF in the joint NDP of P-matrix size (4 or 8), a starting stream index for the second AP in the NDP, an Nss for the first AP in the NDP (e.g., rows of the P-matrix to use), an Nss for the second AP in the NDP (e.g., rows of the P-matrix to use), GI and LTF symbol duration, and a TXOP duration in the joint NDP preamble.

In some cases, the information to be conveyed to the second AP (and the STAs) via the NDPA preceding a joint NDP may include a STAID, such as a special value in the case of the NDPA carrying the STAID, that may be an eleven bit COBF APID. The STAID may be referred to as a COBF special APID. In some cases, the COBF APID may be self-picked by the second AP, and updated if collision is noticed; collisions may be resolved in a manner similar to resolving BSS color collisions. In some cases, the COBF special APID may be advertised in the beacon as a form of an AP identifier. The information or common parameters to be conveyed in the NDPA may include a bandwidth (3 bits) and punctured channel information (5 bits). The NDPA may include a number of long training field (NLTF) symbols in the NDP of P-matrix size (1 bit of 4 or 8) or the NLTF field (and the 1 bit) may be removed if the NLTF in the joint NDP is set to a fixed value, e.g., 8. The NPDA may include a starting stream index for the second AP in the NDP (2 bits of 3, 4, 5, or 6), a number of spatial streams (Nss) for the first AP in the NDP (2 bits of 1, 2, 3, or 4, or 2 bits of 2, 3, 4, 5), and a number of spatial streams (Nss) for the second AP in the NDP (2 bits of 1, 2, 3, or 4, or 2 bits of 2, 3, 4, 5). The NDPA may include a guard interval (GI) and long training field (LTF) symbol duration (1 bit of 2× LTF+1.6CP and 4× LTF+3.2CP) or the GI and LTF field (and the 1 bit) may be removed from the NDPA if the GI and LTF symbol duration is set to a fixed configuration, e.g., 2× LTF+1.6CP. In some cases, The NDPA may include a TXOP duration in the joint NDP (7 bits). In some cases, the NDPA may include transmission error vector magnitude (EVM) information (2 bits), such as a maximum modulation and coding scheme (MCS) in the first BSS associated with the first AP to allow the second AP to choose a transmit power to meet the EVM requirements of the MCS.

In some cases, the information to be conveyed to the second AP (and the STAs) via the NDPA preceding a joint NDP may include a null data packet announcement variant subfield, a sounding dialog token number subfield, a first station information field and a second station information field. The first station information field may indicate for second AP to perform the joint sounding procedure. The second station information field may indicate a STA (or multiple STAs) associated with the joint sounding procedure for providing sounding feedback. In some cases, the null data packet announcement variant subfield may be set to 3 to indicate an extremely high throughput (EHT) null data packet announcement frame. A subfield within the sounding dialog token number subfield being set to a certain value may indicate UHR null data packet announcement frame. The sounding dialog token number subfield being set to a certain value or a subfield within the sounding dialog token number subfield being set to a certain value may indicate the first station information field carries information for the second AP. An association identifier (AID11) subfield in the first station information field being set to a certain value may indicate the first station information field carries information for the second AP where the certain value in the AID11 subfield may be values of 2007-2047 or one of 2008-2042 or 2046. The sounding dialog token number subfield being set to a certain value, a subfield within the sounding dialog token number subfield being set to a certain value, the association identifier (AID11) subfield in the first station information field being set to a certain value, or a coordinated sounding type subfield in the first station information field being set to a certain value may indicate the joint sounding procedure.

Referring to FIG. 5, the example communication timelines 500 illustrate a joint sounding protocol. The sounding may occur one BSS at a time, and communication timelines 500 illustrate a case with two APs, such as AP 102-f and AP 102-g, with one STA per AP, such as STA 104-c associated with AP 102-f and STA 104-d associated with AP 102-g, such as part of the same BSS. In some examples, the AP 102-f (sharing AP) may transmit the joint sounding trigger 502. In some cases, the AP 102-f (sharing AP) does not transmit the joint sounding trigger 502. The AP 102-f may transmit the NDPA 504. The AP 102-f may transmit the NDP 506, and the AP 102-g may transmit the NDP 508. In the joint sounding procedure, the two NDPs (e.g., NDP 506 and NDP 508) may act like one NDP from the viewpoint of the receiver (STAs associated with the first AP), so the two NPDs may be referred to as one joint NDP. The two NDPs (e.g., NDP 506 and NDP 508) may be synchronized in time and frequency, may have symbol alignment, may share a common preamble up to UHR-SIG, and may have mutually exclusive sets of spatial streams in UHR-STF and UHR-LTF. In some examples, the AP 102-f may transmit a beamforming report poll (BFRP) frame 510. The STA 104-c may transmit joint sounding feedback 512, such as large V feedback where V is a matrix. The AP 102-g (shared AP) may transmit the NDPA 514. The AP 102-g may transmit the NDP 516, and the AP 102-f may transmit the NDP 518. In some examples, the AP 102-g may transmit a beamforming report poll (BFRP) frame 520. The STA 104-d may transmit joint sounding feedback 522, such as large V feedback where V is a matrix. In some examples, the role of the AP 102-g and AP102-f may change in different sounding phases. If the AP 102-g is the sharing AP and the AP 102-f is the shared AP in the first sounding phase, the AP 102-f may be the sharing AP and the AP 102-g may be the shared AP in the seconding sounding phase.

In some cases, a collision of the COBF APID with the STAID may occur if the shared AP (such as AP 102-g) picks a COBF APID that matches the STAID of STA 104-c. To resolve the possible collision, the NDPA may include an ultra-high reliability (UHR) variant of the NDP. The NDP may be a joint sound NDP that includes the reserved state in a sounding dialog token. The NDPA with the UHR variant of the NDP and the sounding dialog token may indicate to the STA 104-c and AP 102-g that a STA information field is meant for AP 102-g at a fixed location. For example, the fixed location may be the first or last STA information field in the NDPA. In some cases, the STA 104-c may ignore the STA information field even if the STAID matches the STA 104-c. The NDPA may be signaled to the AP 102-g, and the NDPA may indicate that the AP 102-g transmits the NDP in response to receiving the NDPA. The NDPA may also indicate that the AP 102-g identifies the special STA information field at either the beginning or the end of the NDPA.

In some examples, the NDPA 514 transmitted by the AP 102-g (sharing AP) may include a bit to indicate to the AP 102-f (shared AP) that the AP 102-g did not receive the packet of the joint sounding feedback 512. In some cases, the same sounding sequence may be used for CSR. For example, one half of the sounding sequence may be used if the shared AP is determining whether the shared AP is causing interference. In some cases, the strength of the OBSS AP interference level may be determined from the V feedback with the relative strength of the elements of V correspond to AP 102-f versus AP 102-g. In some cases, CQI feedback may be based on small V or H and may be used to obtain the OBSS AP interference level in isolation.

In the joint sounding, the NDP (such as NDP 506 and NDP 508) may be transmitted jointly or transmitted at the same time providing less overhead with less NDPAs and less NDPs transmitted. In joint sounding, global CSI may be automatically possible, and the joint sounding may be forward compatible with the joint transmission. In joint sounding, the STA 104-c and the STA 104-d may transmit large V based feedback with no pre-multiplication of in-BSS U matrix before calculating interference channel feedback, no extra matrix multiply operations, no retaining a U matrix from a previous NDP, and no separate treatment of in-BSS and interference channels.

In some cases, the sounding phase may be implemented with sequential sounding. In sequential sounding, NDP of participating APs may be transmitted sequentially. When the channel feedback is transmitted to the interfering AP, the U matrix of the in-BSS channel may be retained. In some cases, for sequential sounding, there may be separate treatment of in-BSS and interference channel feedback at the STA. The automatic gain control (AGC) state may be different for the in-BSS U matrix calculation, and the AGC for the interfering channel that may harm the null space calculations. For example, the impacts of left multiplication of a diagonal matrix on the singular value decomposition (SVD) may not be straight forward, and based on the initial sims, the left multiplication may harm the null space calculations. The sequential sounding may provide higher overhead with the NDPA and preamble of the NDP than the joint sounding.

In some cases, the joint sounding feedback from the STA 104-c and the STA 104-d may be large V feedback or small V feedback. The small V feedback may provide improved performance over large V feedback with approximately 1 dB post processing signal to noise ratio (SNR). The small V feedback may be associated with receive filter pre-multiplication that is more precise than that of large V feedback. The small V feedback may run the SVD engine twice instead of once for large V feedback that may lead to extra latency. In some cases, small V feedback may have pre-multiplication with the U matrix.

In some examples, the NDPA may be modified for joint sounding. The NDPA may be addressed to an in-BSS STA with no changes to BSS ID, such as ID of the AP transmitting the NDPA, and no changes to the STAID. The quantity of streams (columns) being requested in the joint sounding feedback may also not be changed in the NDPA. If the NDPA is transmitted without a preceding transmission of the joint sounding trigger, the STA information field may be addressed to the shared AP to convey the starting and ending stream index for the shared AP indicating the rows of the P-matrix, and the STA information field may use a special STAID.

In joint sounding, the joint NDP may include a common legacy preamble, a universal signal (U-SIG) field and UHR signal common (UHR-SIG-common) field. The U-SIG field may include a BSS color subfield that may be set to the BSS color of the AP that transmits the NDPA. The UHR long training fields (LTF) section may include a quantity of LTFs and Nss which may be equal to the quantity of LTF symbols and Nss subfield in the UHR-SIG-common field. In some cases, the quantity of LTFs may be limited to eight. In some examples, APs having five antennas may use four antennas when implementing COBF. The TXOP field of the NDP may be designed to protect the feedback packet.

In some cases, the AP 102-f may transmit the BFRP frame 510, and the AP 102-g may transmit the BFRP frame 520. The BFRP frame may be transmitted in the case of a single STA, and the feedback may be a TB PPDU. The AP 102-g may decode the BFRP frame 510 to obtain the modulation and coding scheme (MCS) of the frame of the joint sounding feedback 512 for the TB PPDU. The AP 102-f may decode the BFRP frame 520 to obtain the modulation and coding scheme of the frame for the joint sounding feedback 522 for the TB PPDU. The BFRP trigger may provide time for feedback calculations, may indicate the arrival of the feedback packet and may provide a synchronization opportunity. In some cases, the feedback packet may use an MCS that is decodable by the AP 102-f and the AP 102-g.

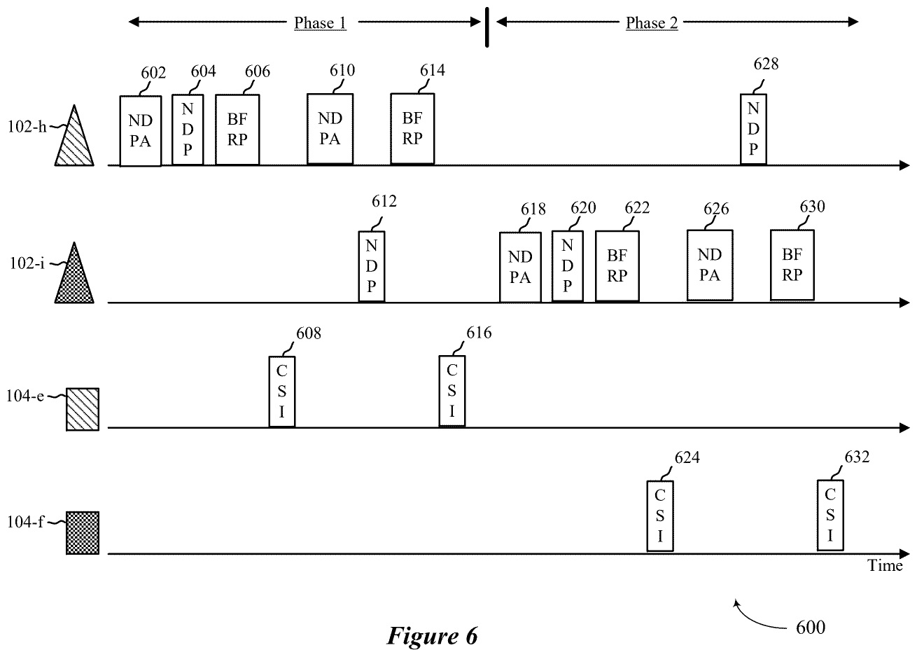

FIG. 6 shows example communication timelines 600 that support techniques for COBF. The communication timelines 600 may implement or be implemented to realize aspects of the wireless communication network 100 or the wireless communication system 200. For example, the communication timelines 600 illustrate signaling exchanges involving an AP 102-h and an AP 102-i, which may be examples of the APs 102 as described herein. For example, the communication timelines 600 illustrate signaling exchanges involving a STA 104-e and a STA 104-f, which may be examples of the STAs 104 as described herein. In some cases, the AP 102-h, the AP 102-i, the STA 104-e and the STA 104-f may perform a sequential sounding protocol or sequential sounding procedure for the sounding phase.

Referring to FIG. 6, the example communication timelines 600 illustrate a sequential sounding protocol. The sounding may occur one BSS at a time, and communication timelines 600 illustrate a case with two APs, such as AP 102-h and AP 102-i, with one STA per AP, such as STA 104-e associated with AP 102-h and STA 104-f associated with AP 102-i, such as part of the same BSS. The STAs associated with AP 102-h, e.g., STA 104-e, may be sounded to provide sounding feedback in phase one, and STAs associated with the AP 102-i, e.g., STA 104-f, may be sounded to provide sounding feedback in phase two. Phase one sounds STA 104-e in BSS1, and phase two sounds STA 104-f in BSS2. For example, the AP 102-h may transmit a NDPA 602 that indicates information for an in-BSS sounding within the sequential sounding procedure. The AP 102-h may transmit a NDP 604. In some examples, the AP 102-h may transmit a BFRP frame 606. The STA 104-e may transmit sounding feedback 608 (e.g., channel state information (CSI)). The AP 102-h may transmit a NDPA 610 that indicates information for a cross-BSS sounding within the sequential sounding procedure. The AP 102-i (shared AP) may transmit a NDP 612. The AP 102-h may transmit a BFRP frame 614. The STA 104-e may transmit sounding feedback 616, such as CSI. In phase two, the AP 102-i may transmit a NDPA 618 that indicates information for an in-BSS sounding within the sequential sounding procedure. The AP 102-i may transmit a NDP 620. In some examples, the AP 102-i may transmit a BFRP frame 622. The STA 104-f may transmit sounding feedback 624 (e.g., CSI). The AP 102-i may transmit a NDPA 626 that indicates information for a cross-BSS sounding within the sequential sounding procedure. The AP 102-h may transmit a NDP 628. The AP 102-i may transmit a BFRP frame 630. The STA 104-f may transmit sounding feedback 632, such as CSI.

In some examples, the NDPA design for sequential sounding may include information for the sequential sounding procedure or cross-BSS sounding. For example, the NDPA may include fields and subfields with information for a cross-BSS sounding within the sequential sounding procedure. For example, the AP 102-h may indicate, via the NDPA to the AP 102-i, a quantity of columns of feedback or a number of columns (Nc) for each STA (e.g., STA 104-e and STA 104-f). In some cases, the AP 102-i may decode multiple STA information fields or the AP 102-i may learn about the Nc from the sounding feedback packet. In some cases, the NDPA may include a subfield to indicate a minimum sounding quantity of spatial streams capability (e.g., 4, 8) for the quantity of stations associated to the first AP that are targeted to provide beamforming feedback in a null data packet (e.g., being sounded). In some cases, the quantity of STAs may be up to two or three per BSS. The NDPA may also convey the bandwidth and punctured channel information of the null data packet. In some cases, the NDPA may convey the GI+LTF or may not convey the GI+LTF as the other AP may pick the GI+LTF. The NDPA may convey the TXOP duration to be set in the NDP preamble or may not convey the TXOP duration as the other AP may select the TXOP duration.

In some cases, the information to be conveyed to the other AP (and the STAs) via the NDPA preceding a sequential NDP may include a STAID, such as a special value in the case of the NDPA carrying the STAID, that may be an eleven bit COBF APID. The STAID may be referred to as a COBF special APID. In some cases, the COBF APID may be self-picked by each of the sharing AP and shared AP, and updated if collision is noticed; collisions may be resolved in a manner similar to resolving BSS color collisions. In some cases, the COBF special APID may be advertised in the beacon as a form of an AP identifier. The information or common parameters to be conveyed in the NDPA may include a bandwidth (3 bits) and punctured channel information (5 bits). The NDPA may include a quantity of STAs or number of STAs (NSTA) (2 bits of 1 or 2). The NPDA may include a subfield to indicate a quantity of columns (Nc) of beamforming feedback matrices for each of the stations associated to the sharing AP that are targeted to provide beamforming feedback in the NDP (2 bits of 1, 2, 3, or 4). In-BSS feedback, the Nc may be expected to be the same as the Nc of the Out-BSS AP. Full nulling may be expected as a default operation for the sequential feedback. The NDPA may include a subfield to indicate a minimum sounding quantity of spatial streams capability for the quantity of stations associated to the first AP that are targeted to provide beamforming feedback in a null data packet (1 bit of 4 or 8). The NDPA may include a GI and long training field (LTF) (1 bit of 2× LTF+1.6CP and 4× LTF+3.2CP) or the GI and LTF field (and the 1 bit) may be removed from the NDPA if the GI and LTF is set to 2× LTF+1.6CP or the GI and LTF is picked by the shared AP. In some cases, the NDPA may include a TXOP duration in the joint NDP (7 bits) or may not include the TXOP duration if the shared AP picks the TXOP duration.

In some cases, the information to be conveyed to the shared AP (and the STAs) via the NDPA preceding a sequential NDP may include a null data packet announcement variant subfield, a sounding dialog token number subfield, a first station information field and a second station information field. The first station information field may indicate for shared AP to perform the sequential sounding procedure. The second station information field may indicate a STA (or multiple STAs) associated with the sequential sounding procedure for providing sounding feedback. In some cases, the null data packet announcement variant subfield may be set to 3 to indicate an extremely high throughput (EHT) null data packet announcement frame. The sounding dialog token number subfield being set to a certain value or a subfield within the sounding dialog token number subfield being set to a certain value may indicate UHR null data packet announcement frame and the first station information field carries information for the shared AP. An association identifier (AID11) subfield in the first station information field being set to a certain value may indicate the first station information field carries information for the shared AP where the certain value in the AID11 subfield may be values of 2007-2047 or one of 2008-2042 or 2046. The sounding dialog token number subfield being set to a certain value, a subfield within the sounding dialog token number subfield being set to a certain value, the association identifier (AID11) subfield in the first station information field being set to a certain value, or a coordinated sounding type subfield in the first station information field being set to a certain value may indicate the sequential sounding procedure.

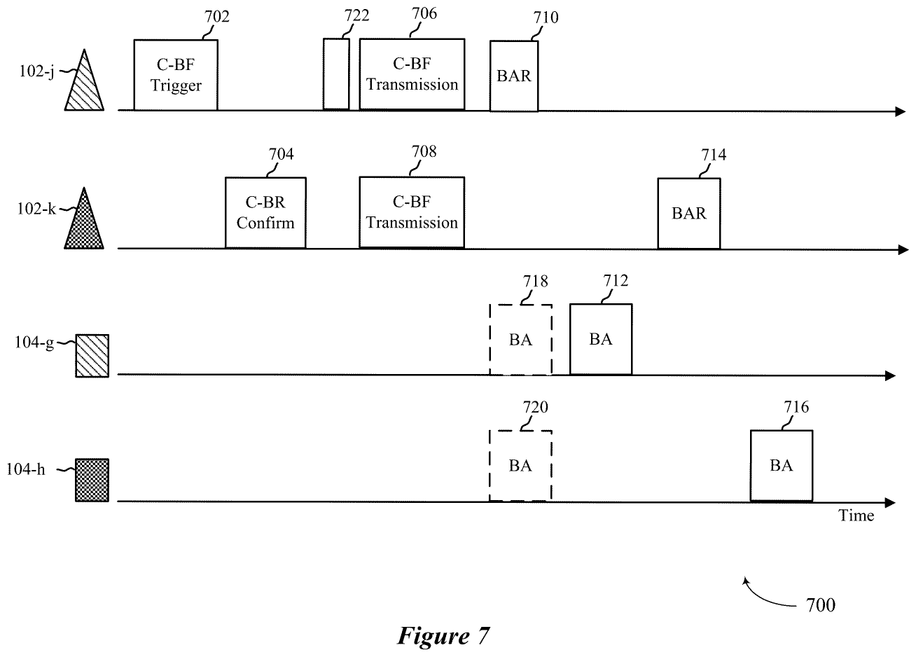

FIG. 7 shows example communication timelines 700 that support techniques for COBF. The communication timelines 700 may implement or be implemented to realize aspects of the wireless communication network 100 or the wireless communication system 200. For example, the communication timelines 700 illustrate signaling exchanges involving an AP 102-j and an AP 102-k, which may be examples of the APs 102 as described herein. For example, the communication timelines 700 illustrate signaling exchanges involving a STA 104-g and a STA 104-h, which may be examples of the STAs 104 as described herein. In some cases, the AP 102-j, the AP 102-k, the STA 104-g and the STA 104-h may perform the COBF transmission phase.

The example communication timelines 700 illustrate a COBF transmission phase. The communication timelines 700 illustrate a case with two APs, AP 102-j and AP 102-k, with one STA per AP, such as STA 104-g associated with AP 102-j and STA 104-h associated with AP 102-k, such as part of the same BSS. In some examples, the AP 102-j (sharing AP) may transmit a COBF trigger 702. The COBF trigger 702 may include the PPDU parameters for aligning the COBF transmission, such as a preamble and a final stream allocation in the BSS of the AP 102-j. The COBF trigger 702 may provide a coarse synchronization opportunity. In some cases, the AP 102-k (shared AP) may transmit a COBF confirm 704. The COBF confirm 704 may act as an acknowledgement of the COBF trigger 702. The COBF confirm 704 may include the PPDU parameters for aligning the COBF transmission, such as preamble and a final stream allocation in the BSS of the AP 102-k. The AP 102-j may transmit the COBF transmission 706, and the AP 102-k may transmit the COBF transmission 708. In some examples, the APs, such as AP 102-j and AP 102-k, may receive acknowledgement feedback using block acknowledgement request (BAR) and block acknowledgement (BA) one BSS at a time. For example, the AP 102-j may transmit the BAR 710 and may receive the BA 712 from the STA 104-g. The AP 102-k may transmit the BAR 714 and may receive the BA 716 from the STA 104-h.

In another example of the COBF transmission phase, the AP 102-j (sharing AP) may transmit the COBF trigger 702. The COBF trigger 702 may provide a coarse synchronization opportunity. In some cases, the COBF trigger 702 may include BA resource orthogonalization information. The BA resource orthogonalization information may indicate orthogonal resources so that the BA 718 and the BA 720 may be communicated orthogonally (e.g., at the same time or at least partially overlapping in time) such that the BA 718 and the BA 720 may be received. The COBF trigger 702 may include the PPDU parameters for aligning the COBF transmission, such as preamble and a final stream allocation in the BSS of the AP 102-j. In some cases, the AP 102-k (sharing AP) may transmit a COBF confirm 704. The COBF confirm 704 may act as an acknowledgement of the COBF trigger 702. The AP 102-j may transmit the COBF transmission 706, and the AP 102-k may transmit the COBF transmission 708. In some examples, the APs, such as AP 102-j and AP 102-k, may receive acknowledgement feedback from the BA 718 transmitted by the STA 104-g and the BA 720 transmitted by the STA 104-h with the BA 718 and BA 720 being transmitted at the same time.

In some examples, the COBF transmission phase may include the AP 102-j transmitting a synchronization frame 722. For example, the AP 102-j may transmit the synchronization frame 722 to the AP 102-k. The AP 102-k may use the synchronization frame 722 to synchronize to the AP 102-j prior to the COBF transmission 706 and COBF transmission 708.

In some examples, for COBF sounding, there may be two types of sounding protocols, joint-NDP based sounding and sequential-NDP based sounding. It may be desirable to unify the NDPA design for the two approaches. In the joint sounding and the cross-BSS section of sequential sounding, some information should be conveyed between APs 102 (e.g., between the AP 102-j and the AP 102-k, or between the AP 102-h and the AP 102-i).

In accordance with examples as described herein, the NDPA may be designed to include the information (e.g., parameters for joint sounding or sequential sounding) for both approaches into a single STA information field. A possible option for the NDPA design, including parameters, and corresponding quantities of bits, is described in the following table:

| | Joint Sounding or cross-BSS | |
|---|---|---|
| Parameter | section of sequential | |
| STAID (special value) | 11 | bit COBF APID |
| BW | 3 | bits |
| Punctured channel information | 5 | bits |
| TXOP duration (in joint NDP) | 7 | bits |
| NLTF in NDP (P-matrix size) | 1 | bit (4 or 8) |
| Disambiguation bit (B27) | 1 | bit |
| Starting stream (e.g., NSTS) | 1-2 | bits |
| index for responding AP in NDP | | |
| NSTS for responding AP in NDP | 0-2 | bits |
| Reserved | 0-3 | bits |

| | |
|---|---|
| GI + LTF | Not needed, only allow |
| | 2x LTF + 1.6 us CP |

The approach may reduce the quantity of bits used for the parameters of NLTF, starting NSTS (number of space-time streams) index for the responding AP 102, and NSTS of the responding AP in the NDP. The NLTF may be needed so that the responding AP 102 knows the size of the P-matrix to use. This might also be linked to LTF capability of the STAs 104 belonging to the AP 102 that transmits the NDPA.

Starting NSTS index may be needed for the responding AP 102 to know which section of P-matrix it can use. The index may be indicated with 1 bit. For example, two choices may correspond to two values of the bit: row 1 onwards for sequential sounding (e.g., corresponding to a first bit value) or row 5 onwards for joint sounding (e.g., corresponding to a second bit value). More options might be needed if we want to support 3 or 5 antenna APs 102, and a quantity higher than 1 bit may be used.

Number of streams may not be needed for sequential sounding as the responding AP 102 can choose its own streams. This information is not needed by the STA 104 before the NDP. Also, the AP 104 might use an NSTS-4 if NLTF=4 and NSTS-8 if NLTF=8. However, for joint sounding, number of streams may be needed as the two APs need to populate a total “NSTS” field in the NDP. In some examples, there may be a rule that a quantity of NSTS is always 4 for joint sounding in which case no bits are needed for indicating the quantity of NSTS. This would allow for the following design (e.g., most optimized, with least quantity of bits used), where 3 bits are left reserved (e.g., unused, saved for future implementations). A possible option for the NDPA design, including parameters, and corresponding quantities of bits, is described in the following table:

| | Joint Sounding or cross-BSS | |
|---|---|---|
| Parameter | section of sequential | |
| STAID (special value) | 11 | bit COBF APID |
| BW | 3 | bits |
| Punctured channel information | 5 | bits |
| TXOP duration (in joint NDP) | 7 | bits |
| NLTF in NDP (P-matrix size) | 1 | bit (4 or 8) |
| Disambiguation bit (B27) | 1 | bit |
| Starting stream (e.g., NSTS) | 1 | bit (1 or 5) |
| index for responding AP in NDP | | |
| NSTS for responding AP in NDP | 0 | bits |
| Reserved | 3 | bits |

| | |
|---|---|
| GI + LTF | Not needed, only allow |
| | 2x LTF + 1.6 us CP |

In some other examples, the starting NSTS index and the quantity of NSTSs may be combined. For example, a bit sequence, such as two bits, may be used to indicate values for the starting NSTS index (e.g., Nsts_start) and the quantity of NSTSs. For instance, the value of the starting NSTS index and the quantity of NSTSs may correspond to a value of a table, as depicted below.

| | Joint Sounding or cross-BSS | |
|---|---|---|
| Parameter | section of sequential | |
| STAID (special value) | 11 | bit COBF APID |
| BW | 3 | bits |
| Punctured channel information | 5 | bits |
| TXOP duration (in joint NDP) | 7 | bits |
| NLTF in NDP (P-matrix size) | 1 | bit (4 or 8) |
| Disambiguation bit (B27) | 1 | bit |
| Starting stream index and NSTSs | 2 | bits |
| quantity for responding AP in NDP | | |
| Reserved | 2 | bits |

| | |
|---|---|
| GI + LTF | Not needed, only allow |
| | 2x LTF + 1.6 us CP |

| Value of the Nsts_start | | |
|---|---|---|
| and NSTSs quantity of | | |
| responding | | Quantity of NSTSs |
| AP combined field | Nsts_start | of responding AP |
| 00 | 1 | 4 |
| 01 | 1 | 8 |
| 10 | 5 | 4 |

| | |
|---|---|
| 11 | Reserved |

In some examples, some STAIDs may be reserved for APIDs (e.g., APID sub-space). For example, 8 or 16 STAIDs may be reserved, such as STAIDs indexed 2040 to 2047. This may help even a UHR STA 104 know that this COBF sounding is being used. The STA 104 may check if STAID of the first STA info field is in the above range, which may indicate that COBF sounding is being used.

In some examples, some of un-used bits (e.g., reserved bits) shown in the special STA info field might be used for a version ID as well. For example, the version ID may allow future versions of this special STA info field to be re-interpreted as a completely different field to convey new information. This may allow future proofing for this special STA info field.

In some cases, there may be concerns that the BSS color in the COBF PPDU can only provide protection in one of the BSSs. There is only one BSS color in the version independent section of the U-SIG which Wi-Fi 7 devices can read. As such, the trigger frame from initiating AP 102 may be configured to provide protection in BSS1. For example, the COBF PPDU carries the BSS color of responding AP in the version independent section and hence providing protection in BSS2. There may also be a rule added (e.g., to MAC specification) that if a packet is seen on the air where the STA 104 can decode U-SIG but it doesn't decode the SR field, OBSS PD based spatial re-use shall be disabled. In some cases, the SR field is not in the version independent section so whenever a Wi-Fi 7 STA 102 sees a UHR PPDU, it will not have access to the SR field.

Accordingly, a first AP may transmit, to a second AP, the NDPA (e.g., NDPA 602) that includes a single special STA info field as described herein, which may enable the first AP to provide parameters (e.g., COBF parameters that the responding AP 102 may use for transmission of an NDP) to the second AP for joint NDP based sounding, sequential NDP based sounding, or both, with just the single STA info field. This reduces the communication overhead in the NDPA which may be seen if additional STA info fields are used to convey this joint or sequential sounding information in the NDPA. It is noted that the NDPA including the single special STA info field may include one or more other STA info fields addressing non-AP STAs, STAs, or the like, that are part of the joint or sequential sounding. In other words, the single special STA info field may refer to a single field in the NDPA that is used to provide common parameters from one AP to another for joint or sequential sounding by two or more APs.

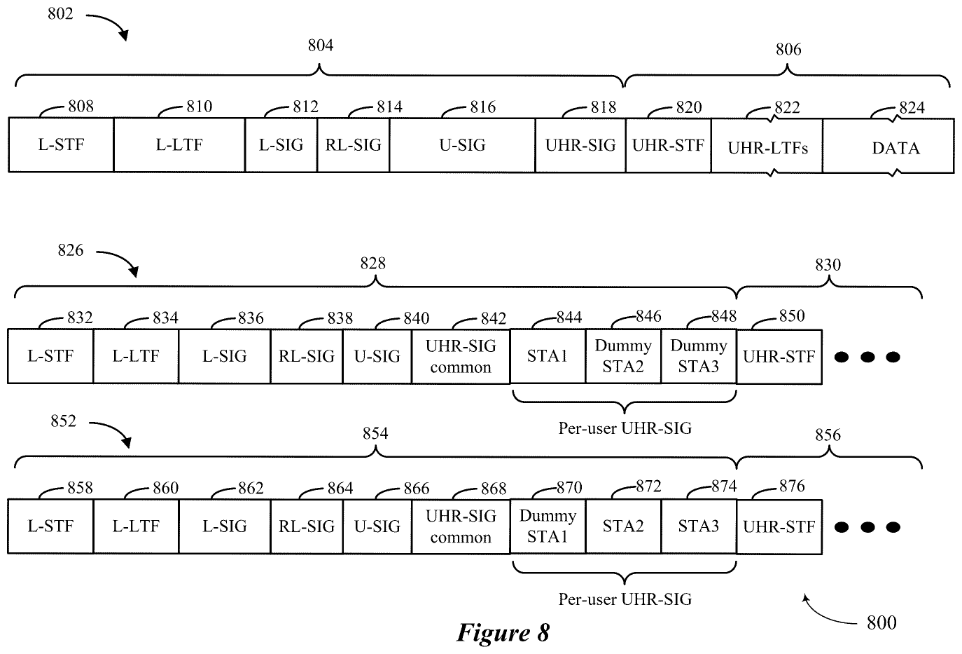

FIG. 8 shows examples of PHY PPDUs 800 that support techniques for COBF. The PHY PPDUs 800 may implement or be implemented to realize aspects of the wireless communication network 100 or the wireless communication system 200. For example, the PHY PPDUs 800 may be usable for COBF communications between the APs and the STAs which may be examples of the APs 102 and the STAs 104 as illustrated by and described with reference to FIGS. 1, 2, 4, 5, and 6.

In some examples, a PHY PPDU 802 may include a pre-UHR portion 804 and a UHR portion 806 that includes a data field 824. The pre-UHR portion 804 includes an L-STF field 808, an L-LTF field 810, an L-SIG field 812, a RL-SIG field 814, a U-SIG field 816, and a UHR-SIG field 818. The UHR portion 806 includes multiple wireless communication protocol version-dependent signal fields including a UHR-STF field 820 and UHR-LFT fields 822. The L-SIG field 812 and the RL-SIG field 814 may each have an individual length. The U-SIG field 816 may include individual BSS color information, and the UHR-SIG field 818 may include BSS specific contents. In some cases, a joint UHR-LTF field may be used for interference suppression, and the pre-UHR portion 804 may not have interference suppression benefits. A quantity of UHR-SIG symbols, a quantity of UHR-LTFs, an LTF symbol duration, and a GI duration may be pre-negotiated among the participating BSSs before the COBF transmission.

In one example, the PHY frame (PHY PPDU 802) may be beamformed from the beginning with both the pre-UHR portion 804 and the UHR portion 806 being beamformed. For this example, the MCS and coding information of all the BSSs may not be available universally and there is not common BSS color setup. The quantity of streams in the pre-UHR portion 804 in a BSS may be one, and the quantity of streams in the UHR portion 806 may be greater than one. Management of the stream indexing and precoding changes may occur from the pre-UHR portion 804 to the UHR portion 806.

In some cases, the UHR-SIG field may carry BSS specific information. In some cases, the UHR-SIG field may carry some information that is quasi-global to enable the STAs to process the PHY frame of the COBF transmission as a regular DL MU-MIMO transmission. For example, the UHR-SIG field may carry information to signal a given number of streams to the STAs of one BSS while also signaling a total number of streams across all of the BSSs. The UHR-LTR section may be transmitted in a joint manner to give each STA an ability to measure the interference channel to all the other streams (including the streams in other BSS). The stream indices being allocated to the STAs may be global indices. In some cases, dummy per-user allocations for OBSS STAs inside a given BSS during UHR-SIG may be introduced in the PHY frame. From the point of view of STAs in a BSS, the allocations to OBSS STAs may look like STAs within the BSS. Since these dummy per-user allocations for OBSS STA may look like within BSS STAs, the processing may be similar to a single-BSS DI. MU-MIMO transmission.

Referring to FIG. 8, a PHY PPDU 826 may be a PHY PPDU of the sharing AP, such as AP 102-j. The PHY PPDU 826 may include a pre-UHR portion 828 and a UHR portion 830. The pre-UHR portion 828 includes an L-STF field 832, an L-LTF field 834, an L-SIG field 836, a RL-SIG field 838, a U-SIG field 840, and a UHR-SIG field. The UHR portion 830 may be similar to the UHR portion 806 including multiple wireless communication protocol version-dependent signal fields including a UHR-STF field 850, UHR-LFT fields and data. The UHR-SIG field may include a common section (UHR-SIG common field 842) and a per-user section. The per user section may include a STA1 field 844, dummy STA2 field 846 and dummy field STA3 848. For this example, STA1 may be associated with the sharing AP (AP 102-j), and STA2 and STA3 may be associated with the shared AP (AP 102-k). The STA2 and STA3 are the recipients of the COBF transmission. In some examples, dummy users in the PPDU in the per-user-SIG portion of the UHR-SIG field may be introduced. The UHR-SIG common field 842 may signal a number of users that corresponds to the total number of users across all BSSs which are receiving this transmission. The UHR-SIG common field 842 may carry a global number of users for this COBF transmission, and in each BSS, the per-user-SIG section carries the dummy users.

In some cases, a PHY PPDU 852 may be a PHY PPDU of the shared AP, such as AP 102-k. The PHY PPDU 852 may include a pre-UHR portion 854 and a UHR portion 856. The pre-UHR portion 854 may include an L-STF field 858, an L-LTF field 860, an L-SIG field 862, a RL-SIG field 864, a U-SIG field 866, and a UHR-SIG field. The UHR portion 856 may be similar to the UHR portion 806 including multiple wireless communication protocol version-dependent signal fields including a UHR-STF field 876, UHR-LFT fields and data. The UHR-SIG field may include a common section (UHR-SIG common field 868) and a per-user section. The per user section may include a dummy STA1 field 870, STA2 field 872 and STA3 field 874. For this example, STA1 may be associated with the sharing AP (AP 102-j), and STA2 and STA3 may be associated with the shared AP (AP 102-k). The STA2 and STA3 are the recipients of the COBF transmission. In some examples, dummy users in the PPDU in the per-user-SIG portion of the UHR-SIG field may be introduced. The UHR-SIG common field 842 may signal a number of users that corresponds to the total number of users across all BSSs which are receiving this transmission. The UHR-SIG common field 842 may carry a global number of users for this COBF transmission, and in each BSS, the per-user-SIG section carries the dummy users.

In one example, the PHY frame (PHY PPDU 802) may be beamformed from the beginning with both the pre-UHR portion 804 and the UHR portion 806 being beamformed. In another example, the pre-UHR portion 804 may not be beamformed. In this example, a common BSS color and the preamble information including STA1D, MCS and coding may be exchanged prior to the COBF transmission.

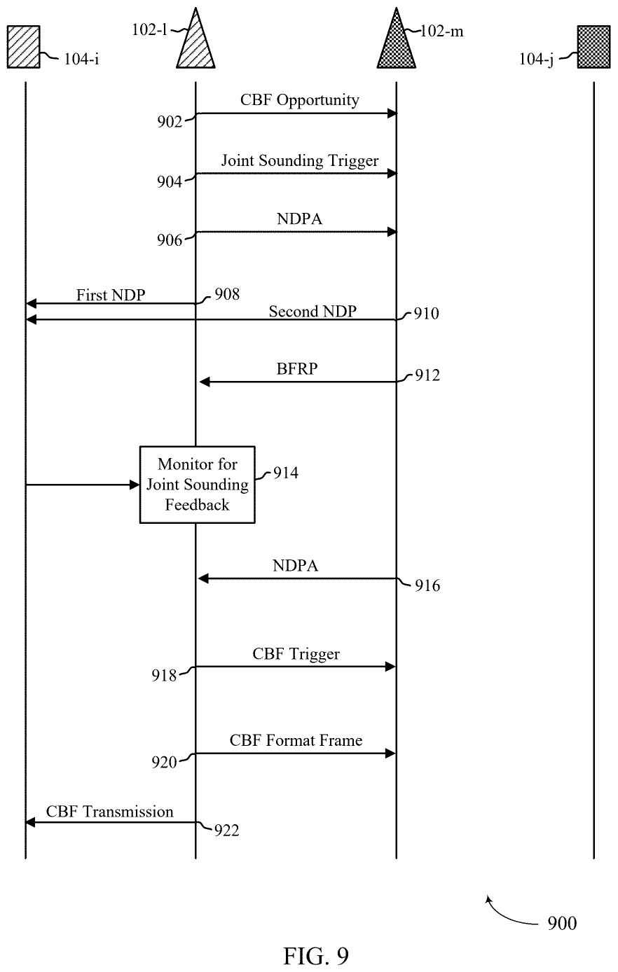

FIG. 9 shows an example process flow 900 that supports techniques for COBF. The process flow 900 may implement or be implemented to realize aspects of the wireless communication network 100, the wireless communication system 200, or one or more of the communication timelines 400, 500, 600, or 700. For example, the process flow 900 illustrates communication between an AP 102-1, an AP 102-m, a STA 104-i, and a STA 104-j, which may be examples of the APs 102 and the STAs 104 as described herein 1, 2, 4, 5, and 6. In some cases, the AP 102-1, the AP 102-m, the STA 104-i, and the STA 104-j may perform COBF group formation, joint sounding, and COBF transmissions. In some cases, the STA 104-i is associated with the AP 102-1, such as part of the same BSS, and the STA 104-j is associated with the AP 102-m, such as part of the same BSS.

In the following description of the process flow 900, the operations may be performed (such as reported or provided) in a different order than the order shown, or the operations performed by the example devices may be performed in different orders or at different times. Some operations also may be left out of the process flow 900, or other operations may be added to the process flow. Further, although some operations or signaling may be shown to occur at different times for discussion purposes, these operations may actually occur at the same time.

At 902, optionally, the AP 102-1 may transmit a signaling indicating a COBF opportunity associated with a COBF transmission, and the COBF transmission may be transmitted during the COBF opportunity. In some examples, the signaling may include a spatial multiplexing capability of the AP 102-1 for the COBF opportunity, and the COBF transmission may be transmitted during the COBF opportunity in accordance with the spatial multiplexing capability. In some cases, the spatial multiplexing capability may include a quantity of antennas of the AP 102-1 associated with the COBF opportunity, and the COBF transmission may be transmitted during the COBF opportunity using the quantity of antennas. In some examples, the signaling may include at least one candidate AP (AP 102-m) associated with the COBF opportunity, and the COBF transmission is transmitted to the at least one candidate AP during the COBF opportunity. In some cases, the signaling indicating the COBF opportunity may be a beacon signal.

At 904, optionally, the AP 102-1 may transmit a joint sounding trigger.

At 906, the AP 102-1 may transmit, to the AP 102-m, a NDPA, and the NDPA may indicate a sounding occasion and one or more common parameters for a first NDP transmission for a joint sounding. In some examples, the NDPA may include a STA information field, the STA information field may include an identifier of the AP 102-1, and the STA information field may be transmitted in the NDPA. In some cases, the NDPA may include a COBF AP identifier of the AP 102-1, and the COBF AP identifier may be transmitted in the NDPA. In some cases, the NDPA may include a sounding dialog token indicating the joint sounding, and the sounding dialog token may be transmitted in the NDPA. In some examples, the NDPA may indicate an UHR variant of the first NDP transmission, and the UHR variant of the first NDP transmission may be transmitted in the NDPA. In some cases, the NDPA may include a STA information field for the AP 102-m. In some examples, the NDPA may indicate at least one of a starting stream index or an ending stream index for the AP 102-m.

At 908, the AP 102-1 may transmit, during the sounding occasion, the first NDP transmission in accordance with the one or more common parameters.

At 910, optionally, the AP 102-m may transmit, during the sounding occasion, a second NDP transmission in accordance with the one or more common parameters.

At 912, optionally, the AP 102-1 may receive, subsequent to the first NDP transmission, a BFRP frame, and a modulation and coding scheme of the joint sounding feedback may be indicated in the BFRP frame.

At 914, the AP 102-1 may monitor for a joint sounding feedback associated with the first NDP transmission and associated with the second NDP transmission during the sounding occasion from the AP 102-1.

At 916, optionally, the AP 102-1 may receive, subsequent to the first NDP transmission, signaling indicating a second NDPA, and the second NDPA may indicate that the AP 102-m did not receive the joint sounding feedback.

At 918, optionally, the AP 102-1 may transmit, based at least in part on the joint sounding feedback and prior to the COBF transmission, a COBF trigger indicating one or more parameters for the COBF transmission. In some cases, the COBF trigger may include information for orthogonalizing BA transmissions.

At 920, optionally, the AP 102-1 may transmit, prior to the COBF transmission, a COBF transmission format frame that may include a pre-ultra-high-reliability portion of a format frame, and the pre-ultra-high-reliability portion may convey identical information in a set of basic service sets associated with the COBF transmission.

At 922, the AP 102-1 may transmit, based at least in part on the joint sounding feedback, a COBF transmission. In some cases, the COBF transmission may include a COBF transmission frame format with a beamformed pre-ultra-high-reliability portion that may indicate information of one basic service set of a set of basic service sets associated with the COBF transmission. The beamformed pre-ultra-high-reliability portion may be transmitted as a single spatial stream for the one basic service set.

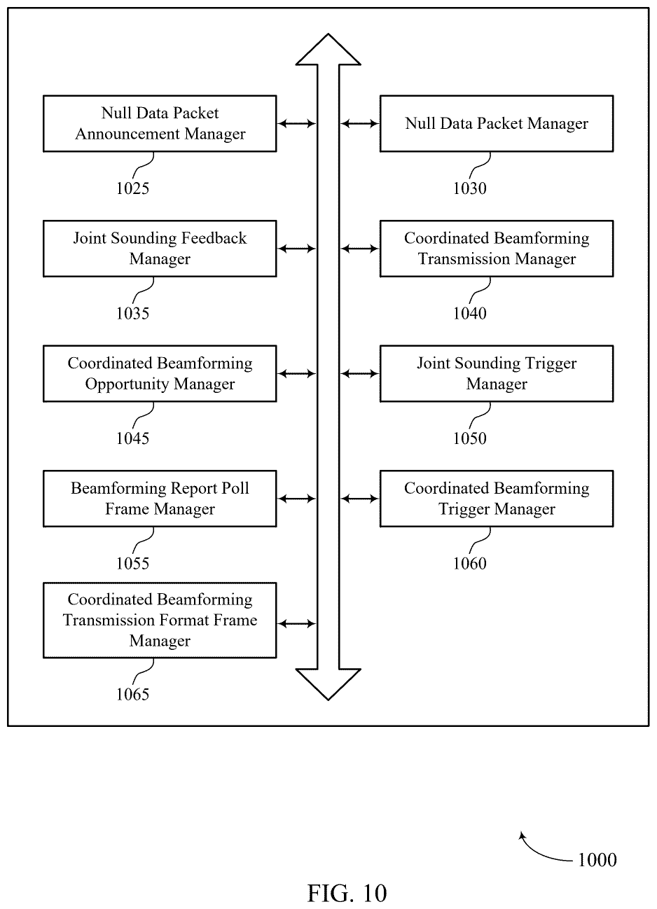

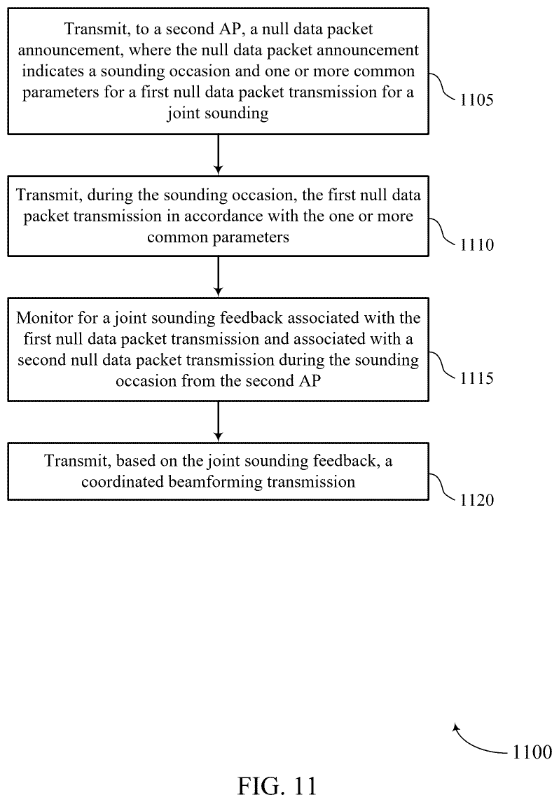

FIG. 10 shows a block diagram of an example wireless communication device 1000 that supports techniques for COBF. In some examples, the wireless communication device 1000 is configured to perform the processes 1100, 1200, 1300, 1400, 1500, and 1600 described with reference to FIGS. 11, 12, 13, 14, 15, and 16, respectively. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP, such as the AP 102 described with reference to FIG. 1. In some other examples, the wireless communication device 1000 can be an AP that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes a null data packet announcement manager 1025, a null data packet manager 1030, a joint sounding feedback manager 1035, a COBF transmission manager 1040, a COBF opportunity manager 1045, a joint sounding trigger manager 1050, a beamforming report poll frame manager 1055, a COBF trigger manager 1060, and a COBF transmission format frame manager 1065. Portions of one or more of the null data packet announcement manager 1025, the null data packet manager 1030, the joint sounding feedback manager 1035, the COBF transmission manager 1040, the COBF opportunity manager 1045, the joint sounding trigger manager 1050, the beamforming report poll frame manager 1055, the COBF trigger manager 1060, and the COBF transmission format frame manager 1065 may be implemented at least in part in hardware or firmware. For example, one or more of the null data packet announcement manager 1025, the null data packet manager 1030, the joint sounding feedback manager 1035, the COBF transmission manager 1040, the COBF opportunity manager 1045, the joint sounding trigger manager 1050, the beamforming report poll frame manager 1055, the COBF trigger manager 1060, and the COBF transmission format frame manager 1065 may be implemented at least in part by at least a processor or a modem. In some examples, portions of one or more of the null data packet announcement manager 1025, the null data packet manager 1030, the joint sounding feedback manager 1035, the COBF transmission manager 1040, the COBF opportunity manager 1045, the joint sounding trigger manager 1050, the beamforming report poll frame manager 1055, the COBF trigger manager 1060, and the COBF transmission format frame manager 1065 may be implemented at least in part by a processor and software in the form of processor-executable code stored in memory.

The wireless communication device 1000 may support wireless communications in accordance with examples as disclosed herein. The null data packet announcement manager 1025 is configurable or configured to transmit, to a second AP, a null data packet announcement, where the null data packet announcement indicates a sounding occasion and one or more common parameters for a first null data packet transmission for a joint sounding. In some cases, the null data packet announcement manager 1025 is configurable or configured to transmit a null data packet announcement, where the null data packet announcement indicates a sounding occasion and one or more common parameters for a first null data packet transmission for a sounding. The null data packet manager 1030 is configurable or configured to transmit, during the sounding occasion, the first null data packet transmission in accordance with the one or more common parameters. The joint sounding feedback manager 1035 is configurable or configured to monitor for a joint sounding feedback associated with the first null data packet transmission and associated with a second null data packet transmission during the sounding occasion from the second AP. In some cases, the joint sounding feedback manager 1035 is configurable or configured to monitor for sounding feedback associated with the first null data packet transmission during the sounding occasion. The COBF transmission manager 1040 is configurable or configured to transmit, based on the joint sounding feedback, a COBF transmission.

In some examples, the COBF opportunity manager 1045 is configurable or configured to transmit, prior to the null data packet announcement, a signaling indicating a COBF opportunity, where the COBF transmission is transmitted during the COBF opportunity.

In some examples, the signaling includes a spatial multiplexing capability of the first AP for the COBF opportunity. In some examples, the COBF transmission is transmitted during the COBF opportunity in accordance with the spatial multiplexing capability.

In some examples, the spatial multiplexing capability includes a quantity of antennas of the first AP associated with the COBF opportunity. In some examples, the COBF transmission is transmitted during the COBF opportunity using the quantity of antennas.

In some examples, the signaling includes at least one candidate AP associated to the COBF opportunity. In some examples, the COBF transmission is transmitted to the at least one candidate AP during the COBF opportunity.

In some examples, the null data packet announcement includes a station information field. In some examples, the station information field includes an identifier of the first AP. In some examples, the station information field is transmitted in the null data packet announcement.

In some examples, the null data packet announcement includes a COBF AP identifier of the first AP. In some examples, the COBF AP identifier is transmitted in the null data packet announcement. In some examples, the null data packet announcement includes a sounding dialog token indicating the joint sounding. In some examples, the sounding dialog token is transmitted in the null data packet announcement.

In some examples, the null data packet announcement indicates an ultra-high reliability variant of the first null data packet transmission. In some examples, the ultra-high reliability variant of the first null data packet transmission is transmitted in the null data packet announcement.

In some examples, the null data packet announcement manager 1025 is configurable or configured to receive, subsequent to the first null data packet transmission, signaling indicating a second null data packet announcement, where the second null data packet announcement indicates that the second AP did not receive the joint sounding feedback. In some examples, the null data packet announcement includes a station information field for the second AP.

In some examples, the null data packet announcement indicates at least one of a starting stream index and an ending stream index for the second AP. In some examples, the joint sounding trigger manager 1050 is configurable or configured to transmit, prior to the null data packet announcement, a joint sounding trigger.

In some examples, the beamforming report poll frame manager 1055 is configurable or configured to receive, subsequent to the first null data packet transmission, a beamforming report poll frame, where a modulation and coding scheme of the joint sounding feedback is indicated in the beamforming report poll frame.

In some examples, the COBF trigger manager 1060 is configurable or configured to transmit, based on the joint sounding feedback and prior to the COBF transmission, a COBF trigger indicating one or more parameters for the COBF transmission.

In some examples, the COBF trigger includes information for orthogonalizing block acknowledgement transmissions.

In some examples, the COBF transmission includes a COBF transmission frame format with a beamformed pre-ultra-high-reliability portion that indicates information of one basic service set of a set of basic service sets associated with the COBF transmission.

In some examples, the beamformed pre-ultra-high-reliability portion is transmitted as a single spatial stream for the one basic service set.

In some examples, the COBF transmission format frame manager 1065 is configurable or configured to transmit, prior to the COBF transmission, a COBF transmission format frame that includes a pre-ultra-high-reliability portion, where the pre-ultra-high-reliability portion conveys identical information in a set of basic service sets associated with the COBF transmission.

In some examples, the signaling indicating the COBF opportunity is a beacon signal.

In some cases, the null data packet announcement may include a null data packet announcement variant subfield, a sounding dialog token number subfield and at least a first station information field and a second station information field. The first station information field may indicate for the second AP to perform a joint sounding procedure or a sequential sounding procedure. The second station information field may indicate a station associated with the joint sounding procedure or the sequential sounding procedure for providing a sounding feedback.

In some examples, the null data packet announcement variant subfield may be set to 3 to indicate an extremely high throughput (EHT) null data packet announcement frame.

In some examples, at least one of the sounding dialog token number subfield being set to a certain value or a subfield within the sounding dialog token number subfield being set to a certain value indicates the first station information field carries information for the second AP. In some examples, an association identifier (AID) subfield in the first station information field being set to a certain value indicates the first station information field carries information for the second AP.

In some examples, at least one of the sounding dialog token number subfield being set to a certain value, a subfield within the sounding dialog token number subfield being set to a certain value, an association identifier (AID) subfield in the first station information field being set to a certain value, or a coordinated sounding type subfield in the first station information field being set to a certain value indicates the joint sounding procedure or the sequential sounding procedure.

In some examples, the first station information field includes a subfield to indicate an identifier of the second AP. In some examples, the subfield to indicate the identifier of the second AP is an association identifier (AID) subfield in the first station information field. In some examples, the null data packet announcement includes a third station information field, and the third station information field includes a subfield with an association identifier (AID11) subfield to indicate an identifier of the second AP.

In some examples, the null data packet announcement includes at least two of a subfield to indicate at least one of a starting stream index for a second AP in the null data packet, a subfield to indicate a quantity of spatial streams for the first AP in the null data packet, a subfield to indicate a quantity of spatial streams for a second AP in the null data packet, or a total quantity of spatial streams in the null data packet.

In some examples, the null data packet announcement includes a subfield to indicate a quantity of spatial streams for the second AP in a null data packet.

In some examples, the null data packet announcement includes a subfield to indicate a quantity of stations associated to the first AP that are targeted to provide beamforming feedback in a null data packet.

In some examples, the null data packet announcement includes a subfield to indicate a quantity of columns of beamforming feedback matrices for each of the quantity of stations associated to the first AP that are targeted to provide beamforming feedback in a null data packet.

In some examples, the null data packet announcement includes at least one of a subfield to indicate a bandwidth associated with a null data packet, a subfield to indicate a punctured channel information associated with the null data packet, one or more subfields to indicate a guard interval associated with the null data packet and a long training field (LTF) symbol duration associated with the null data packet, a subfield to indicate a transmission opportunity duration associated with the null data packet, a subfield to indicate transmission error vector magnitude information associated with the null data packet, or a subfield to indicate a minimum sounding quantity of spatial streams capability for the quantity of stations associated to the first AP that are targeted to provide beamforming feedback in a null data packet.

Additionally, or alternatively, the wireless communication device 1000 may support wireless communications in accordance with examples as disclosed herein. In some examples, the null data packet announcement manager 1025 is configurable or configured to receive, from a second AP, a null data packet announcement indicating a null data packet announcement, where the null data packet announcement indicates a sounding occasion and one or more common parameters for a first null data packet transmission for a joint sounding. In some examples, the null data packet manager 1030 is configurable or configured to transmit, during the sounding occasion, a second null data packet transmission in accordance with the one or more common parameters. In some examples, the joint sounding feedback manager 1035 is configurable or configured to monitor for a joint sounding feedback associated with the first null data packet transmission and associated with the second null data packet transmission during the sounding occasion from the second AP. In some examples, the COBF transmission manager 1040 is configurable or configured to transmit, based on the joint sounding feedback, a COBF transmission.

In some examples, the COBF opportunity manager 1045 is configurable or configured to receive, prior to the null data packet announcement, a signaling indicating a COBF opportunity, where the COBF transmission is transmitted during the COBF opportunity.

In some examples, the signaling includes a spatial multiplexing capability of the second AP for the COBF opportunity. In some examples, the COBF transmission is transmitted during the COBF opportunity in accordance with the spatial multiplexing capability.

In some examples, the spatial multiplexing capability includes a quantity of antennas of the second AP associated with the COBF opportunity. In some examples, the COBF transmission is transmitted during the COBF opportunity using the quantity of antennas. In some examples, the signaling includes at least one candidate AP associated with the COBF opportunity. In some examples, the COBF transmission is transmitted to the at least one candidate AP during the COBF opportunity.

In some examples, the null data packet announcement includes a station information field. In some examples, the station information field includes an identifier of the second AP. In some examples, the station information field is transmitted in the null data packet announcement. In some examples, the null data packet announcement includes a COBF AP identifier of the second AP. In some examples, the COBF AP identifier is transmitted in the null data packet announcement.

In some examples, the null data packet announcement includes a sounding dialog token indicating the joint sounding. In some examples, the sounding dialog token is transmitted in the null data packet announcement.

In some examples, the null data packet announcement indicates an ultra-high reliability variant of the first null data packet transmission. In some examples, the ultra-high reliability variant of the first null data packet transmission is transmitted in the null data packet announcement.

In some examples, the null data packet announcement manager 1025 is configurable or configured to transmit, subsequent to the second null data packet transmission, signaling indicating a second null data packet announcement, where the second null data packet announcement indicating that the first AP did not receive the joint sounding feedback.

In some examples, the null data packet announcement includes a station information field for the first AP. In some examples, the null data packet announcement indicates at least one of a starting stream index and an ending stream index for the first AP. In some examples, the joint sounding trigger manager 1050 is configurable or configured to receive, prior to the null data packet announcement, a joint sounding trigger.

In some examples, the beamforming report poll frame manager 1055 is configurable or configured to receive, subsequent to the first null data packet transmission, a beam forming report poll frame, where a modulation and coding scheme of the joint sounding feedback is indicated in the beamforming report poll frame.

In some examples, the COBF trigger manager 1060 is configurable or configured to receive, based on the joint sounding feedback and prior to the COBF transmission, a COBF trigger indicating one or more parameters for the COBF transmission.

In some examples, the COBF trigger includes information for orthogonalizing block acknowledgement transmissions.

In some examples, the COBF transmission includes a COBF transmission frame format with a beamformed pre-ultra-high-reliability portion that indicates information of one basic service set of a set of basic service sets associated with the COBF transmission. In some examples, the beamformed pre-ultra-high-reliability portion is transmitted as a single spatial stream for the one basic service set.

In some examples, the COBF transmission format frame manager 1065 is configurable or configured to transmit, prior to the COBF transmission, a COBF transmission format frame that includes a pre-ultra-high-reliability portion, where the pre-ultra-high-reliability portion conveys identical information in a set of basic service sets associated with the COBF transmission. In some examples, the signaling indicating the COBF opportunity is a beacon signal.

The null data packet announcement manager 1025 is configurable or

configured to transmit, to a second AP, a null data packet announcement, where the null data packet announcement indicates a sounding occasion and includes a single station information field that indicates a set of multiple common parameters for a first null data packet transmission and a second null data packet transmission, the single station information field indicating the second AP is to transmit the second null data packet transmission for joint sounding or sequential sounding. The null data packet manager 1030 is configurable or configured to transmit, during the sounding occasion, the first null data packet transmission in accordance with the set of multiple common parameters. The joint sounding feedback manager 1035 is configurable or configured to monitor for one or more sounding feedback messages associated with the first null data packet transmission and associated with the second null data packet transmission. The COBF transmission manager 1040 is configurable or configured to transmit, based on the one or more sounding feedback messages, a coordinated beamforming transmission.

In some examples, the set of multiple common parameters includes one or more bits indicating a starting spatial stream index and a quantity of spatial streams for the second AP.

In some examples, the one or more bits include a bit sequence that indicates the starting spatial stream index and the quantity of spatial streams for the second AP based on a value from a table corresponding to the bit sequence. In some examples, the bit sequence includes a two-bit sequence.

In some examples, the one or more bits include a first bit indicating the starting spatial stream index, a first value of the first bit corresponding to a first starting spatial stream index and a second value of the first bit corresponding to a second starting spatial stream index. In some examples, the one or more bits include a second bit indicating the quantity of spatial streams, a first value of the second bit corresponding to a first quantity and a second value of the second bit corresponding to a second quantity.

In some examples, the set of multiple common parameters include a parameter indicating a number of long training fields in the first null data packet transmission, the number of long training fields corresponding to a matrix size. In some examples, the parameter includes a single bit, and a first value of the single bit corresponds to a first matrix size and a second value of the single bit corresponds to a second matrix size.

In some examples, the null data packet announcement manager 1025 is configurable or configured to transmit, to a second AP, a null data packet announcement, where the null data packet announcement indicates a sounding occasion and includes a single station information field that indicates a set of multiple common parameters for a first null data packet transmission and a second null data packet transmission, the single station information field indicating the second AP is to transmit the second null data packet transmission for joint sounding or sequential sounding. In some examples, the null data packet manager 1030 is configurable or configured to transmit, during the sounding occasion, the first null data packet transmission in accordance with the set of multiple common parameters. In some examples, the joint sounding feedback manager 1035 is configurable or configured to monitor for one or more sounding feedback messages associated with the first null data packet transmission and associated with the second null data packet transmission. In some examples, the COBF transmission manager 1040 is configurable or configured to transmit, based on the one or more sounding feedback messages, a coordinated beamforming transmission.

In some examples, the set of multiple common parameters includes one or more bits indicating a starting spatial stream index and a quantity of spatial streams for the second AP.

In some examples, the one or more bits include a bit sequence that indicates the starting spatial stream index and the quantity of spatial streams for the second AP based on a value from a table corresponding to the bit sequence.

In some examples, the bit sequence includes a two-bit sequence.

In some examples, the one or more bits include a first bit indicating the starting spatial stream index, a first value of the first bit corresponding to a first starting spatial stream index and a second value of the first bit corresponding to a second starting spatial stream index.

In some examples, the one or more bits include a second bit indicating the quantity of spatial streams, a first value of the second bit corresponding to a first quantity and a second value of the second bit corresponding to a second quantity.

In some examples, the set of multiple common parameters include a parameter indicating a number of long training fields in the first null data packet transmission, the number of long training fields corresponding to a matrix size.

In some examples, the parameter includes a single bit, and a first value of the single bit corresponds to a first matrix size and a second value of the single bit corresponds to a second matrix size.

FIG. 11 shows a flowchart illustrating an example process 1100 performable by or at a first AP that supports techniques for COBF. The operations of the process 1100 may be implemented by a first AP or its components as described herein. For example, the process 1100 may be performed by a wireless communication device, such as the wireless communication device 1000 described with reference to FIG. 10, operating as or within a wireless AP. In some examples, the process 1100 may be performed by a wireless AP, such as one of the APs 102 described with reference to FIG. 1.

In some examples, in 1105, the first AP may transmit, to a second AP, a null data packet announcement, where the null data packet announcement indicates a sounding occasion and one or more common parameters for a first null data packet transmission for a joint sounding. The operations of 1105 may be performed in accordance with examples as disclosed herein. In some implementations, aspects of the operations 1105 may be performed by a null data packet announcement manager 1025 as described with reference to FIG. 10.

In some examples, in 1110, the first AP may transmit, during the sounding occasion, the first null data packet transmission in accordance with the one or more common parameters. The operations of 1110 may be performed in accordance with examples as disclosed herein. In some implementations, aspects of the operations of 1110 may be performed by a null data packet manager 1030 as described with reference to FIG. 10.

In some examples, in 1115, the first AP may monitor for a joint sounding feedback associated with the first null data packet transmission and associated with a second null data packet transmission during the sounding occasion from the second AP. The operations of 1115 may be performed in accordance with examples as disclosed herein. In some implementations, aspects of the operations of 1115 may be performed by a joint sounding feedback manager 1035 as described with reference to FIG. 10.

In some examples, in 1120, the first AP may transmit, based on the joint sounding feedback, a COBF transmission. The operations of 1120 may be performed in accordance with examples as disclosed herein. In some implementations, aspects of the operations of 1120 may be performed by a COBF transmission manager 1040 as described with reference to FIG. 10.

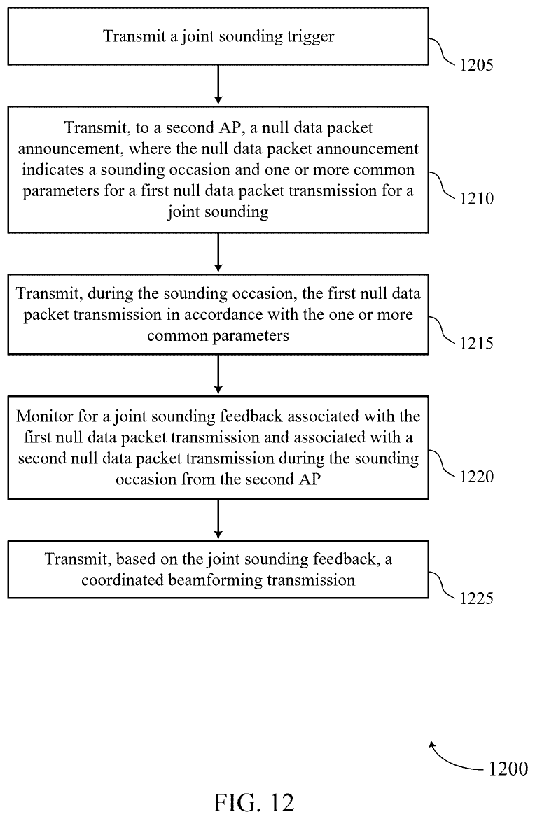

FIG. 12 shows a flowchart illustrating an example process 1200 performable by or at a first AP that supports techniques for COBF. The operations of the process 1200 may be implemented by a first AP or its components as described herein. For example, the process 1200 may be performed by a wireless communication device, such as the wireless communication device 1000 described with reference to FIG. 10, operating as or within a wireless AP. In some examples, the process 1200 may be performed by a wireless AP, such as one of the APs 102 described with reference to FIG. 1.

In some examples, in 1205, the first AP may transmit a joint sounding trigger. The operations of 1205 may be performed in accordance with examples as disclosed herein. In some implementations, aspects of the operations of 1205 may be performed by a joint sounding trigger manager 1050 as described with reference to FIG. 10.

In some examples, in 1210, the first AP may transmit, to a second AP, a null data packet announcement, where the null data packet announcement indicates a sounding occasion and one or more common parameters for a first null data packet transmission for a joint sounding. The operations of 1210 may be performed in accordance with examples as disclosed herein. In some implementations, aspects of the operations of 1210 may be performed by a null data packet announcement manager 1025 as described with reference to FIG. 10.

In some examples, in 1215, the first AP may transmit, during the sounding occasion, the first null data packet transmission in accordance with the one or more common parameters. The operations of 1215 may be performed in accordance with examples as disclosed herein. In some implementations, aspects of the operations of 1215 may be performed by a null data packet manager 1030 as described with reference to FIG. 10.

In some examples, in 1220, the first AP may monitor for a joint sounding feedback associated with the first null data packet transmission and associated with a second null data packet transmission during the sounding occasion from the second AP. The operations of 1220 may be performed in accordance with examples as disclosed herein. In some implementations, aspects of the operations of 1220 may be performed by a joint sounding feedback manager 1035 as described with reference to FIG. 10.

In some examples, in 1225, the first AP may transmit, based on the joint sounding feedback, a COBF transmission. The operations of 1225 may be performed in accordance with examples as disclosed herein. In some implementations, aspects of the operations of 1225 may be performed by a COBF transmission manager 1040 as described with reference to FIG. 10.

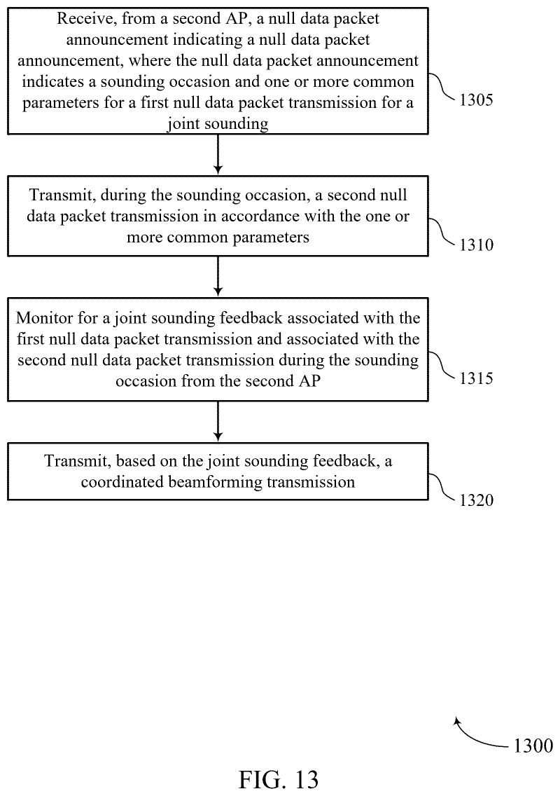

FIG. 13 shows a flowchart illustrating an example process 1300 performable by or at a first AP that supports techniques for COBF. The operations of the process 1300 may be implemented by a first AP or its components as described herein. For example, the process 1300 may be performed by a wireless communication device, such as the wireless communication device 1000 described with reference to FIG. 10, operating as or within a wireless AP. In some examples, the process 1300 may be performed by a wireless AP, such as one of the APs 102 described with reference to FIG. 1.

In some examples, in 1305, the first AP may receive, from a second AP, a null data packet announcement indicating a null data packet announcement, where the null data packet announcement indicates a sounding occasion and one or more common parameters for a first null data packet transmission for a joint sounding. The operations of 1305 may be performed in accordance with examples as disclosed herein. In some implementations, aspects of the operations of 1305 may be performed by a null data packet announcement manager 1025 as described with reference to FIG. 10.

In some examples, in 1310, the first AP may transmit, during the sounding occasion, a second null data packet transmission in accordance with the one or more common parameters. The operations of 1310 may be performed in accordance with examples as disclosed herein. In some implementations, aspects of the operations of 1310 may be performed by a null data packet manager 1030 as described with reference to FIG. 10.

In some examples, in 1315, the first AP may monitor for a joint sounding feedback associated with the first null data packet transmission and associated with the second null data packet transmission during the sounding occasion from the second AP. The operations of 1315 may be performed in accordance with examples as disclosed herein. In some implementations, aspects of the operations of 1315 may be performed by a joint sounding feedback manager 1035 as described with reference to FIG. 10.

In some examples, in 1320, the first AP may transmit, based on the joint sounding feedback, a COBF transmission. The operations of 1320 may be performed in accordance with examples as disclosed herein. In some implementations, aspects of the operations of 1320 may be performed by a COBF transmission manager 1040 as described with reference to FIG. 10.

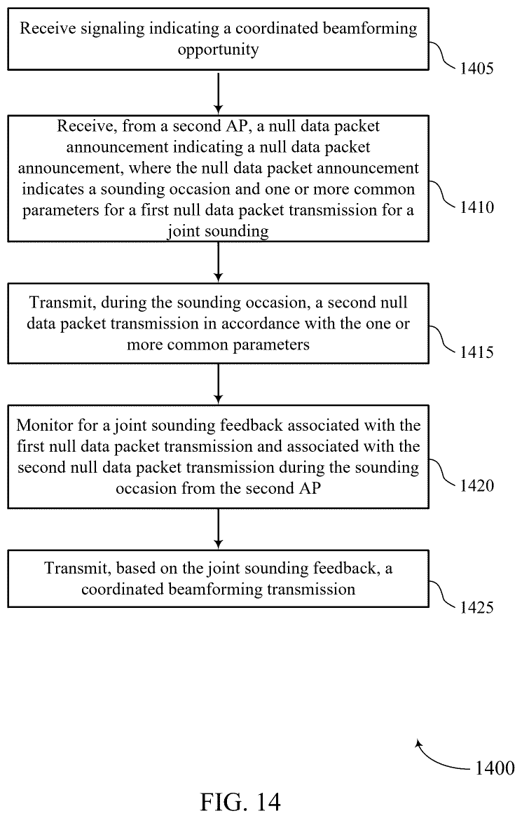

FIG. 14 shows a flowchart illustrating an example process 1400 performable by or at a first AP that supports techniques for COBF. The operations of the process 1400 may be implemented by a first AP or its components as described herein. For example, the process 1400 may be performed by a wireless communication device, such as the wireless communication device 1000 described with reference to FIG. 10, operating as or within a wireless AP. In some examples, the process 1400 may be performed by a wireless AP, such as one of the APs 102 described with reference to FIG. 1.

In some examples, in 1405, the first AP may receive signaling indicating a COBF opportunity. The operations of 1405 may be performed in accordance with examples as disclosed herein. In some implementations, aspects of the operations of 1405 may be performed by a COBF opportunity manager 1045 as described with reference to FIG. 10.

In some examples, in 1410, the first AP may receive, from a second AP, a null data packet announcement indicating a null data packet announcement, where the null data packet announcement indicates a sounding occasion and one or more common parameters for a first null data packet transmission for a joint sounding. The operations of 1410 may be performed in accordance with examples as disclosed herein. In some implementations, aspects of the operations of 1410 may be performed by a null data packet announcement manager 1025 as described with reference to FIG. 10.

In some examples, in 1415, the first AP may transmit, during the sounding occasion, a second null data packet transmission in accordance with the one or more common parameters. The operations of 1415 may be performed in accordance with examples as disclosed herein. In some implementations, aspects of the operations of 1415 may be performed by a null data packet manager 1030 as described with reference to FIG. 10.

In some examples, in 1420, the first AP may monitor for a joint sounding feedback associated with the first null data packet transmission and associated with the second null data packet transmission during the sounding occasion from the second AP. The operations of 1420 may be performed in accordance with examples as disclosed herein. In some implementations, aspects of the operations of 1420 may be performed by a joint sounding feedback manager 1035 as described with reference to FIG. 10.

In some examples, in 1425, the first AP may transmit, based on the joint sounding feedback, a COBF transmission. The operations of 1425 may be performed in accordance with examples as disclosed herein. In some implementations, aspects of the operations of 1425 may be performed by a COBF transmission manager 1040 as described with reference to FIG. 10.

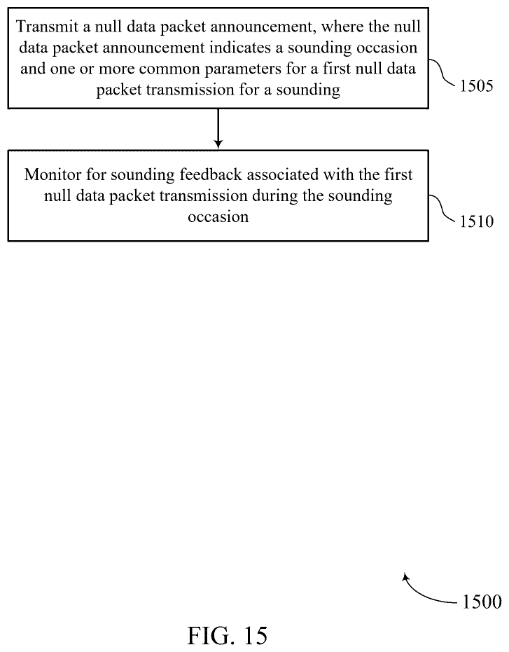

FIG. 15 shows a flowchart illustrating an example process 1500 performable by or at a first AP that supports techniques for coordinated beamforming. The operations of the process 1500 may be implemented by a first AP or its components as described herein. For example, the process 1500 may be performed by a wireless communication device, such as the wireless communication device 1000 described with reference to FIG. 10, operating as or within a wireless AP. In some examples, the process 1500 may be performed by a wireless AP, such as one of the APs 102 described with reference to FIG. 1.

In some examples, in 1505, the first AP may transmit a null data packet announcement, where the null data packet announcement indicates a sounding occasion and one or more common parameters for a first null data packet transmission for a sounding. The operations of 1505 may be performed in accordance with examples as disclosed herein. In some implementations, aspects of the operations of 1505 may be performed by a null data packet announcement manager 1025 as described with reference to FIG. 10.

In some examples, in 1510, the first AP may monitor for the sounding feedback associated with the first null data packet transmission during the sounding occasion. The operations of 1510 may be performed in accordance with examples as disclosed herein. In some implementations, aspects of the operations of 1510 may be performed by a joint sounding feedback manager 1035 as described with reference to FIG. 10.

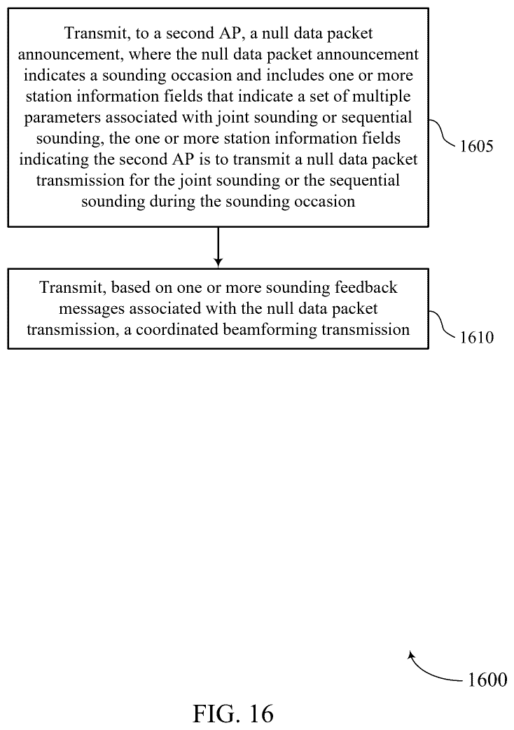

FIG. 16 shows a flowchart illustrating an example process 1600 performable by or at a first AP that supports enhancements to NDPA design for indicating COBF parameters in a single special STA info field. The operations of the process 1600 may be implemented by a first AP or its components as described herein. For example, the process 1600 may be performed by a wireless communication device, such as the wireless communication device 1000 described with reference to FIG. 10, operating as or within a wireless AP. In some examples, the process 1600 may be performed by a wireless AP, such as one of the APs 102 described herein.

In some examples, in 1605, the first AP may transmit, to a second AP, a null data packet announcement, where the null data packet announcement indicates a sounding occasion and includes one or more station information fields that indicate a set of multiple parameters associated with joint sounding or sequential sounding, the one or more station information field indicating the second AP is to transmit a null data packet transmission for the joint sounding or the sequential sounding during the sounding occasion. The operations of 1605 may be performed in accordance with examples as disclosed herein. In some implementations, aspects of the operations of 1605 may be performed by a null data packet announcement manager 1025 as described with reference to FIG. 10.

In some examples, in 1610, the first AP may and transmit, based on one or more sounding feedback messages associated with the null data packet transmission, a coordinated beamforming transmission. The operations of 1610 may be performed in accordance with examples as disclosed herein. In some implementations, aspects of the operations of 1610 may be performed by a COBF transmission manager 1040 as described with reference to FIG. 10.

Implementation examples are described in the following numbered clauses:
Clause 1: A method by a first AP, comprising: transmitting, to a second AP, a null data packet announcement, wherein the null data packet announcement indicates a sounding occasion and includes one or more station information fields that indicate a plurality of parameters associated with joint sounding or sequential sounding, the one or more station information fields indicating the second AP is to transmit a null data packet transmission for the joint sounding or the sequential sounding during the sounding occasion; and transmitting, based at least in part on one or more sounding feedback messages associated with the null data packet transmission, a coordinated beamforming transmission.
Clause 2: The method of aspect 1, wherein the plurality of parameters comprises two or more bits indicating a starting spatial stream index and a quantity of spatial streams for the second AP.
Clause 3: The method of aspect 2, wherein the two or more bits comprise a first bit that indicates the starting spatial stream index and a second bit that indicates the quantity of spatial streams for the second AP.
Clause 4: The method of aspect 3, wherein the two or more bits comprise two bits.
Clause 5: The method of any of aspects 2 through 4, wherein a first value of the first bit corresponds to a first starting spatial stream index and a second value of the first bit corresponds to a second starting spatial stream index.
Clause 6: The method of aspect 5, wherein a first value of the second bit corresponds to a first quantity and a second value of the second bit corresponds to a second quantity.
Clause 7: The method of any of aspects 1 through 6, wherein the plurality of parameters comprises a parameter indicating a number of long training fields in the null data packet transmission, the number of long training fields corresponding to a matrix size.
Clause 8: The method of aspect 7, wherein the parameter comprises a single bit, and a first value of the single bit corresponds to a first matrix size and a second value of the single bit corresponds to a second matrix size.
Clause 9: The method of any of aspects 1 through 8, wherein the plurality of parameters comprises a station identifier that identifies the second AP.
Clause 10: The method of aspect 9, wherein the station identifier comprises a first value within a subset of values for the station identifier that identifies the second AP, and wherein an overall set of possible values for the station identifier is larger than the subset of values and includes the subset of values.
Clause 11: A first AP comprising one or more memories storing processor-executable code, and one or more processors coupled with the one or more memories and individually or collectively operable to execute the code to cause the first AP to perform a method of any of aspects 1 through 10.
Clause 12: A first AP comprising at least one means for performing a method of any of aspects 1 through 10.
Clause 13: A non-transitory computer-readable medium storing code the code comprising instructions executable by one or more processors to perform a method of any of aspects 1 through 10.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
transmit, to a second AP, a null data packet announcement, wherein the null data packet announcement indicates a sounding occasion and includes one or more station information fields that indicate a plurality of parameters associated with joint sounding or sequential sounding, the one or more station information fields further indicating the second AP is to transmit a null data packet transmission for the joint sounding or the sequential sounding during the sounding occasion; and
transmit, based at least in part on one or more sounding feedback messages associated with the transmitted null data packet transmission, a coordinated beamforming transmission.

2. The first AP of claim 1, wherein the plurality of parameters comprises two or more bits indicating a starting spatial stream index and a quantity of spatial streams for the second AP.

3. The first AP of claim 2, wherein the two or more bits comprise a first bit that indicates the starting spatial stream index for the second AP and a second bit that indicates the quantity of spatial streams for the second AP.

4. The first AP of claim 3, wherein the two or more bits comprise two bits.

5. The first AP of claim 3, wherein a first value of the first bit corresponds to a first starting spatial stream index and a second value of the first bit corresponds to a second starting spatial stream index, the second starting spatial stream index different to the first starting spatial stream index.

6. The first AP of claim 3, wherein a first value of the second bit corresponds to a first quantity of spatial streams for the second AP and a second value of the second bit corresponds to a second quantity of spatial streams for the second AP, wherein the first quantity is different to the second quantity.

7. The first AP of claim 1, wherein the plurality of parameters comprises a parameter indicating a number of long training fields in the null data packet transmission, the number of long training fields corresponding to a matrix size.

8. The first AP of claim 7, wherein the parameter comprises a single bit, and a first value of the single bit corresponds to a first matrix size and a second value of the single bit corresponds to a second matrix size, wherein first matrix size is different to the second matrix size.

9. The first AP of claim 1, wherein the plurality of parameters comprises a station identifier that identifies the second AP.

10. The first AP of claim 9, wherein the station identifier comprises a first value within a subset of values for the station identifier that identifies the second AP, and wherein an overall set of possible values for the station identifier is larger than the subset of values and includes the subset of values.

11. The first AP of claim 1, wherein the one or more station information fields indicate a version identifier.

12. A method by a first access point (AP), comprising:
transmitting, to a second AP, a null data packet announcement, wherein the null data packet announcement indicates a sounding occasion and includes one or more station information fields that indicate a plurality of parameters associated with joint sounding or sequential sounding, the one or more station information fields further indicating the second AP is to transmit a null data packet transmission for the joint sounding or the sequential sounding during the sounding occasion; and
transmitting, based at least in part on one or more sounding feedback messages associated with the transmitted null data packet transmission, a coordinated beamforming transmission.

13. The method of claim 12, wherein the plurality of parameters comprises two or more bits indicating a starting spatial stream index and a quantity of spatial streams for the second AP.

14. The method of claim 13, wherein the two or more bits comprise a first bit that indicates the starting spatial stream index for the second AP and a second bit that indicates the quantity of spatial streams for the second AP.

15. The method of claim 14, wherein the two or more bits comprise two bits.

16. The method of claim 14, wherein a first value of the first bit corresponds to a first starting spatial stream index and a second value of the first bit corresponds to a second starting spatial stream index, the second starting spatial stream index different to the first starting spatial stream index.

17. The method of claim 14, wherein a first value of the second bit corresponds to a first quantity of spatial streams for the second AP and a second value of the second bit corresponds to a second quantity of spatial streams for the second AP, wherein the first quantity is different to the second quantity.

18. The method of claim 12, wherein the plurality of parameters comprises a parameter indicating a number of long training fields in the null data packet transmission, the number of long training fields corresponding to a matrix size.

19. A non-transitory computer-readable medium storing code, the code comprising instructions executable by one or more processors to:
transmit, to a second AP, a null data packet announcement, wherein the null data packet announcement indicates a sounding occasion and includes one or more station information fields that indicate a plurality of parameters associated with joint sounding or sequential sounding, the one or more station information fields indicating the second AP is to transmit a null data packet transmission for the joint sounding or the sequential sounding during the sounding occasion; and
transmit, based at least in part on one or more sounding feedback messages associated with the null data packet transmission, a coordinated beamforming transmission.

20. The non-transitory computer-readable medium of claim 19,
wherein the plurality of parameters comprises two bits indicating a starting spatial stream index and a quantity of spatial streams for the second AP.
